(19) United States
(12) Patent Application Publication
(10) Pub. No.: US 2025/0153088 A1
(43) Pub. Date: May 15, 2025

(54) SCALABLE SORTIVE GAS SEPARATOR AND METHOD OF OPERATION

(71) Applicant: SVANTE INC., Burnaby (CA)

(72) Inventors: Jamie MCKERROW, Delta (CA); Wes ARNOLD, Burnaby (CA); Joel CIZERON, Burnaby (CA); Keir PRITCHARD, Kelowna (CA); Josh GLADSTONE, Montreal (CA); Guy PEARSON, Burnaby (CA)

(21) Appl. No.: 18/729,695

(22) PCT Filed: Mar. 12, 2023
(86) PCT No.: PCT/IB2023/052355

§ 371 Date: Jul. 17, 2024

Related U.S. Application Data
(60) Provisional application No. 63/321,470, filed on Mar. 18, 2022.

(51) Int. Cl. B01D 53/06; B01D 53/62

(52) U.S. Cl. CPC B01D 53/06; B01D 53/62; B01D 2257/504

(57) ABSTRACT

A rotating toroid for supporting a plurality of sorbent vessels therein and has sealing assemblies. The rotating toroid is fluidly isolated from stationary stator assemblies having stationary ducting and stationary sealing assemblies. The sealing assemblies of the rotating toroid and the sealing assemblies of the stationary stator assemblies work in cooperation with one another to fluidly isolate the plurality of sorbent vessels. As the toroid rotates about a rotational axis, each of the plurality of vessels passes by each of the stationary sealing assemblies, allowing a fluid to flow from one stationary assembly, through the sorbent vessel, to another stationary sealing assembly, allowing the sorbent vessel to sorb or desorb a fluid component.

### FIELD

Embodiments disclosed herein generally relate to sorptive gas separators with moving vessels containing solid sorbents, and more particularly to the constructional details.

### BACKGROUND

Large scale chemical separations are typically carried out using distillation techniques. The need to remove large amounts of CO₂ from dilute gaseous streams of industrial emissions using different technologies, such as adsorptive separation, is a very challenging technical problem.

Adsorptive separation using liquid amines for example requires large contactor towers to enable the exchange of CO₂ between large volumes of gas and an amine-containing liquid.

Sorptive gas separation processes employing solid sorbents have been developed with advantageous smaller contactor volumes. One such technology employing a rapid cycle moisture swing process was demonstrated at a modest CO₂ separation capacity of 10,000 metric tons per year (MTPY) from a flue gas stream. A rotary sorptive gas separator with a 4 meter diameter contactor containing between 1 to 2 metric tons (MT) of adsorbent material was employed with a process cycle time as low as one minute. However, CO₂ separation and purification from flue gas at this small scale is not likely to be economically viable due to high capital cost versus potential revenues generated from CO₂ separation. While this modest size demonstration proves the viability of the process and sorbent system, scaling up the machine to carry out CO₂ separation at millions of metric tons per year presents novel challenges.

Adsorptive gas separation processes and systems, for example, temperature swing sorption, pressure swing sorption, vacuum swing sorption and partial pressure swing sorption, are known in the art for their use in sorptive gas separation of multi-component fluid mixtures.

Conventional temperature swing sorptive gas separation processes typically employ two fundamental steps, a sorption step and a regeneration step. During the sorption step, a feed stream such as a multi-component fluid mixture at a lower temperature is typically admitted into a sorptive gas separator having a contactor comprising a sorbent material, wherein the sorbent material can sorb a target component of the feed stream, separating the sorbed target component from the remaining components of the feed stream. A first product stream depleted of the target component relative to the feed stream can then be recovered from the contactor and sorptive gas separator. That is, a concentration of the target component in the first product stream is less than a concentration of the target component in the feed stream.

During one or more subsequent regeneration steps, typically at least one fluid stream at a higher temperature is admitted into the sorptive gas separator and contactor to increase the temperature of the sorbent material, causing the sorbed target component to release or desorb from the sorbent material, and to allow for cyclic reuse of the sorbent material.

A second product stream enriched in the target component relative to the feed stream can then be recovered from the contactor and sorptive gas separator. More specifically, a concentration of the target component in the second product stream is higher than the concentration of the target component in the feed stream.

During an optional cooling or conditioning step, typically a fluid stream at a lower temperature is admitted into the sorptive gas separator and contactor to decrease the temperature of the sorbent material in preparation for a subsequent sorption step. In general, the sorbing, regenerating and conditioning steps may then be sequentially repeated.

Some sorptive gas separation processes using moisture swing sorbent regeneration step, may have 4 to 8 process steps and between 3 to 6 inlet process streams.

In conventional sorptive gas separation processes and systems, energy consumed for regeneration of the sorbent material can typically represent a large portion of the operating cost of such systems and processes, and such costs typically act as barriers to wide adoption and implementation of conventional sorptive gas separation technology. More complex cycles are typically created to improve the separation performance of the process with, for example, use of additional purge steps to increase product purity, or use of multiple sorbent conditioning steps to improve the control of sorbent moisture loading and sorbent temperature.

Sorptive gas separators may be configured with multiple sorbent beds, multiple sorbent contactors or multiple zones, such as for example, a plurality of discrete sorbent beds or contactors, where at least one contactor moves through a plurality of substantially fluidly-separated stationary zones within the sorptive gas separator while performing different steps of a sorptive gas separation process.

Sorptive gas separators may also be configured where the various fluid streams supplied to and recovered from the sorptive gas separator are supplied and collected at fixed locations while the sorbent beds or contactors or zones move.

Sorptive gas separators with solid sorbents which move or rotate present several design challenges including, for example, achieving a short cycle time for the sorptive gas process, achieving adequate sealing of the various fluid streams between dynamic and static components, and limiting undesirable heat transfer between beds, contactors and/or zones within a sorptive gas separator which may undesirably result in reduced performance of a sorptive gas separator and process. Furthermore, thermal cycling of components in such devices may undesirably reduce the life expectancy of some sorptive gas separators or sorbent contactor components.

The amount of sorbent employed to carry out the gas separation is generally inversely proportional to the cycle duration. Therefore, the ability to carry out rapid sorptive process cycles has a large impact on the size of the sorptive gas separator and on the economic viability of the process.

With a global need for CO₂ removal exceeding 1GT per year, commercial installations having gas separation capacities of, for example, from 200,000 MTPY to 2,000,000 MTPY, are desired. An efficient design for a rapid cycle sorptive gas separator capable of moving 20 MT to 400 MT of sorbent material through a set of process steps rapidly, in minutes to tens of seconds, is needed to meet the desired global gas separation capacities.

Scaling up of sorptive gas separators using rotating sorbent wheels, presents multiple challenges including designing a structure of the sorptive gas separator that is as light as possible while enabling accurate and repeatable positioning of the seals, and seal performance at the interface of the rotor and stator. The size of the final structure also makes transportation of the structure or components to the site difficult.

Additional challenges of large scale sorptive gas separators include achieving adequate sealing of the process and product gas streams in the sorptive gas separator while switching the streams fed and recovered from the sorbent rapidly, for example, within one minute a sorbent vessel may come in contact with at least 4 different process streams. Therefore, the available time for opening and closing a passage to the sorbent vessel when switching streams is short in duration.

Small scale sorptive gas separators can be configured where the sorbents are contained in two or more enclosures or vessels mounted on a rotor driven by and rotated around a central shaft. Passages in the enclosures or vessels enable the different streams to flow in and out of the enclosures to come in contact with the sorbent. Sorptive gas separators employing a pressure swing process with a rotor having an outer diameter of typically less than 2 meters is disclosed in European Patent Publication EP3613491A1. The dynamic or moving enclosure(s) or vessel(s) may have a sealing surface or counter-face plate which moves and slides against a stationary sealing surface or a stationary seal-face of a stator for forming a seal between the vessel and ambient environment as well as a seal between vessels, while enabling a process and product gas stream to flow through into and out of the vessel(s) via the seal-face and counter-face plate. Production and deployment of large components such as a stationary seal-face and/or a moving counter-face plate with a span of greater than five meters presents challenges such as manufacturing components with tight tolerances required for desired sealing (for example, tolerances of less than a millimeter over a distance greater than about five meters), manufacturing and installation costs, and handling and transportation of large-scale components. During operation of a sorptive gas separator of this type, challenges of maintaining alignment between moving and stationary sealing surfaces, thermal expansion and contraction of each seal-face or counter-face plate over a large span, can compromise the effective mating of components resulting in leakage of the process and product gas streams. Another challenge with such large scale sorptive gas separators is the application and transfer of a motive force needed to accelerate and move the sorbents (which can weigh greater than about 10 metric tons) and associated hardware, while overcoming the friction between the stationary and moving or sliding sealing surfaces, such as, a moving counter-face plate and a stationary seal-face. Applying a motive force to move the entire weight of the sorbent and associated hardware through a single point with a concentrated force may result in deflection of components and localized stress requiring oversizing of components which, in turn, increases component costs. Further challenges of large scale sorptive gas separators include a large footprint or area that is occupied by the sorptive gas separator, especially in applications where the area available is limited, for example, in retrofit applications where a sorptive gas separator is to be added to an existing facility or plant, such as an electric power plant.

The life cycle costs of sorptive gas separators must be considered for commercial operations and acceptance of the various technologies. Capital cost or intensity of a sorptive gas separator can be assessed by evaluating the amount of structure required to control the position and motion of the sorbent vessels.

Maintenance of a sorptive gas separator may include replacing and/or servicing of assemblies and components such as sorbent materials, seals, and other components with a limited life. Ridged and/or load bearing structures along with conduits for the process and product gas streams typically enclose a sorbent gas separator on all sides which restricts access to and impede the replacement of assemblies and components. The restricted accessibility to components causes complexity, delays and increases downtime, increasing the impact and cost of maintenance.

Sealing the interface between a moving toroid that is functioning as a multi-stream separation system, and especially for large radius system (e.g. greater than 4 meters in diameter) requires a high tolerance to surface roughness of the counter-face of a seal. Traditional prior art seals require at least a root mean square (RMS) roughness of the counter-face of no more than 0.4 microns, with higher quality seals requiring an RMS roughness as low as 0.1 microns or even 0.01 microns. Such extremely smooth surfaces over the large area of the scale of such systems that are economical to operate are very challenging or costly to produce and maintain in a large scale gas separation system. Therefore, there is a significant incentive to create a seal system capable of achieving low leak rates. Seals to address these deficiencies in the prior art are the subject of this invention.

Traditionally, large scale gas treatment equipment and facilities are uniquely engineered and fabricated for a single specific application, process, and site. A modular design which enables volume manufacturing with reduced on-site fabrication costs and installation costs are also desired.

The present invention provides solutions for sorptive gas separation processes and applications, for example, separation of CO₂ from an industrial, commercial, process, combustion or flue gas stream, where a gas stream which a component is desirably separated from has a large gas flow rate (>20,000 Nm³/h), and at low pressures (<100 kPag). The solutions include providing an effective sorptive gas separator design for moving sorbent contactors between process streams and recovering the process stream effluents without significant leaks, and a novel multi-stream selector valve design with a novel seal system design enabling long seal life and high seal performance with low leak rates than can be used in a sorptive gas separator at larger scales, for example, greater than 5 m in diameter.

### SUMMARY

In a broad aspect of the invention, a multi-stream selector valve comprises a rotating toroid, a set of ducts and duct connectors, a support structure for a drive and wheels supporting the toroid as well as positioning the set of ducts and duct connectors for forming a stator assembly, and seal assemblies including flexible wearable seal components in contact with the rotating toroid, the seal assemblies being subject to friction. In embodiments, the rotating toroid can be attached to at least one circular rail and supported by wheels placed in fix positions and distributed at angular increments to contact the circular rail simultaneously, the wheels providing both reacting forces to a static load of the toroid with at least one wheel providing a motive force for rotating the toroid. In further embodiments, at least one face of the toroid is substantially flat or in a shape of a frustum of a cone, and is adapted to be used as an interface for a sliding seal or seal face of the toroid integrated therein.

In another broad aspect of the invention, a sliding seal system for a toroidally shaped multi-stream selector valve comprises an inner diameter flexible seal ring further comprising multiple wearable segments with a Mohs hardness below 4, an outer diameter flexible seal ring further comprising multiple wearable segments which are free to move in the direction of an axis of rotation of a toroid with Mohs hardness below 4, a set of urging elements for pressing on the wearable segment to apply a distributed force in a direction of a sliding seal face, and radial seal elements placed between and in contact with the inner diameter seal ring and outer diameter seal ring for separating different streams entering or exiting a multi-stream selector valve, wherein the seal system can be configured to provide stream separation for 2 to 20 inlet streams while preventing process stream leakage into an ambient environment or ambient environment fluid leaking into a process stream.

In another broad aspect, a rotating toroid comprises at least one circular rail operatively connected to an inner diameter of the rotating toroid, a set of wheels placed in fixed positions and distributed at angular increments along the inner diameter for contacting the at least one circular rail, wherein the set of wheels are adapted to provide reacting forces to a static load of the toroid, and at least one wheel of the set of wheels is adapted to provide a motive force for rotating the toroid, without being driven or supported by a central shaft, and wherein the toroid further comprises at least one substantially flat face which is adapted to be used as an interface for at least one sliding seal or at least one seal face integrated in a sorption separation machine or a multi-stream selector valve.

Yet, in another broad aspect of the invention, a sorptive gas separator comprises a rotating toroid having at least one circular rail operatively connected to an inner diameter of the rotating toroid, a set of wheels placed in fixed positions and distributed at angular increments along the inner diameter for contacting the at least one circular rail, wherein the set of wheels are adapted to provide reacting forces to a static load of the toroid, and at least one wheel of the set of wheels is adapted to provide a motive force for rotating the toroid, without being driven or supported by a central shaft, and wherein the toroid further comprises at least one substantially flat face which is adapted to be used as an interface for at least one sliding seal or at least one seal face integrated in a sorption separation machine or a multi-stream selector valve. In embodiments, the sorptive gas separator can further comprise a plurality of sorbent vessels containing sorbent contactors, a set of ducts and duct connectors, a support structure for a drive and wheels supporting the toroid as well as positioning the set of ducts and duct connectors for forming a stator assembly, and seal assemblies including flexible wearable seal components in contact with a moving toroid seal face or seal faces, the seal assemblies being subject to friction, wherein the sorptive gas separator is adapted to be connected to at least a duct for conveying a feed stream, a duct for conveying a regeneration stream, a duct for conveying a product stream, and a duct for conveying a waste product stream.

In another broad aspect of the invention, a sorptive gas separator, for separating a first component from a multi-component fluid stream, comprises a toroid having at least one circular rail operatively connected to an inner diameter of the rotating toroid, a set of wheels placed in fixed positions and distributed at angular increments along the inner diameter for contacting the at least one circular rail, wherein the set of wheels are adapted to provide reacting forces to a static load of the toroid, and at least one wheel of the set of wheels is adapted to provide a motive force for rotating the toroid, without being driven or supported by a central shaft, and wherein the toroid further comprises at least one substantially flat face which is adapted to be used as an interface for at least one sliding seal or at least one seal face integrated in a sorption separation machine or a multi-stream selector valve. In embodiments, the sorptive gas separator further comprises a plurality of vessels, wherein said plurality of vessels are mobile and each house a sorbent for sorbing said first component therein from said multi-component fluid stream, at least one stator side seal assembly having duct connectors, inner and outer perimeter seals, and radial seals, a plurality of motors for transferring a motive force to said plurality of vessels, a first process stream duct for directing said multi-component fluid stream as a feed stream to said plurality of said vessels, wherein said feed stream duct is substantially stationary, a first product stream duct for directing a first product stream recovered from said plurality of said vessels, wherein said first product stream duct is substantially stationary, a second process stream duct for directing a first regeneration stream to said plurality of said vessels, wherein said first regeneration stream duct is substantially stationary, and a second product stream duct for directing a second product stream recovered from said plurality of said vessels, wherein said second product stream duct is substantially stationary.

In a further aspect of the invention, a sorptive gas separator comprises a rotating assembly for rotating around an axis having a toroid shaped support structure having an interior side located on an inner perimeter of said rotating assembly, an exterior side located on an outer perimeter of said rotating assembly, a first span located between said interior side and said exterior side, a second span located between said interior side and said exterior side, a plurality of vessels, attachable within said toroid shaped support structure, enclosing a solid sorbent, said plurality of vessels having an inlet and an outlet in fluid communication with said solid sorbent, and at least one protrusion attached to said interior side of said rotating assembly. In embodiments, the sorptive gas separator further comprises a stationary assembly having a plurality of drive wheels, said plurality of drive wheel coupled to a plurality of motors for transferring a motive force for moving said rotating assembly around said axis, and at least one seal system for directing inlet streams through the said plurality of vessels and recovering a product stream from said plurality of vessels, the at least on seal system comprising a rotor seal face and a stator side wearable seal assembly, wherein said stationary assembly is located within said interior side of said rotating assembly.

Further still, in another broad aspect of the invention, a method of operating an adsorptive gas separator for separating a first component from a multi-component fluid stream, comprises providing a rotating toroid having at least one circular rail operatively connected to an inner diameter of the rotating toroid, a set of wheels placed in fixed positions and distributed at angular increments along the inner diameter for contacting the at least one circular rail, wherein the set of wheels are adapted to provide reacting forces to a static load of the toroid, and at least one wheel of the set of wheels is adapted to provide a motive force for rotating the toroid, without being driven or supported by a central shaft, and wherein the toroid further comprises at least one substantially flat face which is adapted to be used as an interface for at least one sliding seal or at least one seal face integrated in a sorption separation machine or a multi-stream selector valve. In embodiments, the sorptive gas separator can further comprise a plurality of sorbent vessels containing sorbent contactors, a set of ducts and duct connectors, a support structure for a drive and wheels supporting the toroid as well as positioning the set of ducts and duct connectors for forming a stator assembly, and seal assemblies including flexible wearable seal components in contact with a moving toroid seal face or seal faces, the seal assemblies being subject to friction, wherein the sorptive gas separator is adapted to be connected to at least a duct for conveying a feed stream, a duct for conveying a regeneration stream, a duct for conveying a product stream, and a duct for conveying a waste product stream. In embodiments, the method further comprises transferring a motive force from said plurality of motors to the toroid for moving said plurality of vessels, fluidly connecting said plurality of said plurality of vessels with a feed stream duct and a first product stream duct, directing said multi-component fluid stream as a feed stream to said plurality of vessels, sorbing said first component onto said sorbent of said plurality of vessels for forming a first product stream depleted in said first component relative to said feed stream, recovering said first product stream from said plurality of vessels and directing said first product stream into said first product stream duct, fluidly connecting said sorbent of said plurality of vessels with said first regeneration stream duct and said second product stream duct, and directing a first regeneration stream to said plurality of vessels, desorbing said first component from said plurality of vessels for forming a second product stream enriched in said first component relative to said feed stream, recovering said second product stream from said plurality of vessels, and directing said second product stream into said second product stream duct.

### BRIEF DESCRIPTION OF THE DRAWINGS

FIG. 1 is a perspective view of an embodiment of the present invention illustrating a sorptive gas separator with a rotating toroidal assembly having a plurality of sorbent vessels fluidly connected to a plurality of static ducts and diffusers positioned above and below the toroidal assembly;

FIG. 2 is a side view of the embodiment of the sorptive gas separator shown in FIG. 1;

FIG. 3 is a perspective view of an embodiment of the present invention illustrating a toroidal assembly having a support frame, and a sorbent vessel with a counter-face plate;

FIG. 4 is a magnified view of a portion of FIG. 3, illustrating the embodiment support frame and the sorbent vessel with a counter-face plate;

FIG. 5 is a perspective view of a portion of an embodiment of the present invention illustrating a support frame and a plurality of motive counter-face plates;

FIG. 6 is a magnified perspective view of a portion of an embodiment of the present invention illustrating a toroidal assembly with a plurality of sorbent vessels, a plurality of motors for moving the toroidal assembly, and a plurality of ducts and diffusers;

FIG. 7 is a perspective view of an embodiment of the present invention illustrating a toroidal support structure and plurality of motors employed to move the toroid support structure;

FIG. 8a is a section view of an embodiment of the present invention illustrating a lower portion of a sorbent vessel, a connector and a counter-face plate;

FIG. 8b is a sectional view of an embodiment of the present invention illustrating a flexible connector which enables the counter-face plate to flex in at least one direction;

FIG. 9 is an exploded view of components of an embodiment of the present invention illustrating a toroidal assembly, a sorbent vessel, and a plurality of diffusers;

FIG. 10a is a schematic representation of cross-sectional plan view of an embodiment of the present invention illustrating a toroidal assembly attached to a cantilever and a rail and supported by a set of wheels and an axis of rotation;

FIG. 10b is a schematic top view of the toroidal assembly of FIG. 10a, showing the location of the set of wheels in relation to the toroidal assembly;

FIG. 11 is a magnified detailed view of an embodiment of the present invention illustrating a portion of the sorptive gas separator forming the multi-stream selector valve;

FIG. 12a is a perspective cross-sectional view of an embodiment of the present invention illustrating an inner diameter seal;

FIG. 12b is a perspective cross-sectional view of the embodiment of the present invention shown in FIG. 12a, illustrating the inner diameter seal, an outer diameter seal, and a plurality of radial seals;

FIG. 13 is a photograph of the frame of the sorptive gas separator from example 1, with the rotor supported by motorized wheels on the inner diameter of the toroidal assembly. The inner diameter of the sorptive gas separator is about 10 meters and the outer diameter of the sorptive gas separator is about 14 meters;

FIG. 14 is a graph representing load on the y-axis and time on the x-axis with a plot 1401 representing the vertical load on one of eight wheels supporting the exemplary toroid structure of example 1 versus time when the toroid is rotated at about 1 rpm, and a plot 1402 representing the total weight of the toroid structure; and

FIG. 15 is a graph representing position on the y-axis and angular position on the x-axis, and a plot of the vertical profile along a circular path on the bottom seal face measured 7 meters from the center of rotation versus angular position of example 1 toroid.

### DETAILED DESCRIPTION

### Definitions

Machine: a sorptive gas separator or a gas separator. The terms machine, separator, gas separator and sorptive gas separator may be used interchangeably herein.

Vessel: an enclosure having an inlet and outlet, for housing a solid sorbent. The terms vessel and sorbent vessels may be used interchangeably herein.

Counter face: a mating surface which mates with a seal element or sealing surfaces, preferably on the rotor or motive side. Typical materials for the counter face includes steel, while materials for the seal elements includes Teflon. The term counter face and motive seal face is used interchangeably herein.

Cᵥ or valve flow coefficient: the volume (in US gallons) of water at 60° F. that will flow through a valve per minute with a pressure drop of 1 psi across the valve.

SAB: a structured adsorbent bed which comprises flow channels distributed substantially evenly between sorbent structures such as sheets, ribbons, high surface area extrudates and the like. SABs can also comprise a honeycomb-like structure with walls coated with sorbent material or comprising sorbent material. The terms structured adsorbent bed, SAB, sorbent contactor, and contactor may be used interchangeably herein.

Degree of freedom: for a rigid object translation or directions of movement on the X-axis, Y-axis, Z-axis, and rotation around each of these axes.

Designed degree of freedom: excluding for small deformation due to applied forces, remaining degree of freedom to move or orient part of an assembly. For example, a wagon on a track has one designed degree of freedom. A scissor lift attached to a wagon would have an additional degree of freedom with elevation of the lift in addition of position of the wagon along the track.

Diffuser: also referred to as duct connector expanding the flow cross section from a small cross section at the duct connection to a larger cross section at the interface with the rotor assembly.

Duct: a passage or a conduit to direct and contain a fluid stream.

Duct connector: a transition vessel directing and containing a fluid between a duct and an inlet or outlet discharge face positioned in close proximity to the rotor seal face and covering a radial segment of the seal face.

Rotor: or rotor assembly, structure that is spun or moved during the operation of the multi-stream selector valve or operation of the sorptive separation machine. The terms rotor, toroid assembly, toroidal assembly, rotating assembly may be used interchangeably herein.

Span: a distance or dimension between two points on a substantially lateral or horizontal plane, for example, a distance or dimension between an outer diameter and an inner diameter where the diameters are measured from a common central axis and on a substantially lateral or horizontal plane.

Process gas: a fluid supplied to or admitted into a sorptive gas separator, for example, a feed stream, a regeneration stream, and/or a cooling stream.

Product gas: a fluid stream recovered from a sorptive gas separator, for example, a first product stream, a second product stream.

Seal or seals: element preventing gas flow at the interface between different components such as rotor seal face and stator gas manifold or removable sorbent vessel and rotor.

Torus or Toroid: three-dimensional object with a substantially annular cross-sectional shape along a plane substantially perpendicular to a selected axis of rotation. The torus or toroid may be substantially extruded or extended from an annular flat face in a perpendicular direction to the axis of rotation or an annular base, and optionally have a shape with different annular cross sections and dimensions at different distances from the base or face in a direction perpendicular to the axis of rotation or face. The terms torus and toroid may be used interchangeably herein.

### Description

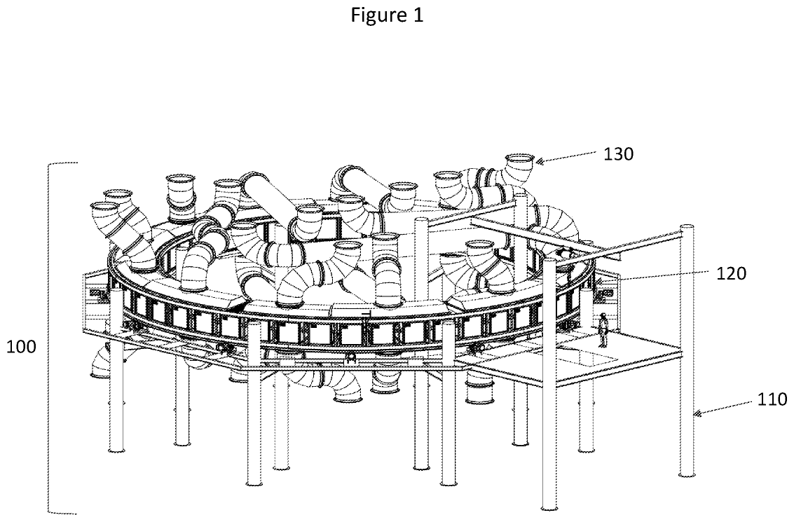

With reference to FIG. 1, a sorptive gas separator 100, includes supporting elements 110 to the ground, a rotating assembly 120 in a shape of a toroid comprising a plurality of sorbent vessels and two sets of a plurality of ducts 130 each supported on a stator, for fluidic connections between the stators and the rotating assembly 120. The ducts can be substantially fixed or stationary. As shown, an exemplary human figure is added for scale with a loading platform to handle installation of sorbent vessels into the rotating assembly. In this example the external or outer diameter of the machine is approximately 24 meters, having 48 sorbent vessels with a total of about 150 cubic meter of sorbent material. The carbon dioxide purification capacity of this machine would be between 1000 to 3000 metric tons per day, depending on flue gas feed composition.

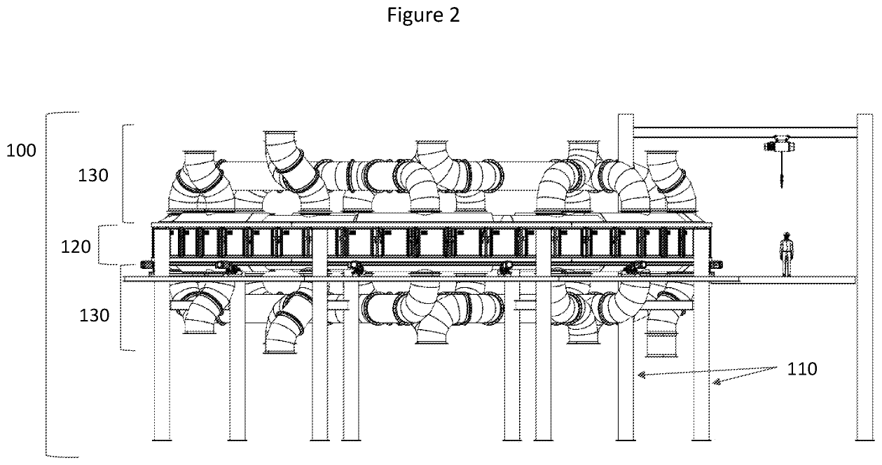

As shown in FIG. 2, a plurality of ducts 130 can be stationary and the ducts are fluidly connected to the balance of the plant and a process gas source (such as a flue gas source) for receiving and recovering fluid streams. The rotating assembly 120 contains the support structure with sorbent vessels and portions of sliding valve elements enabling a multi-stream switching function of the machine.

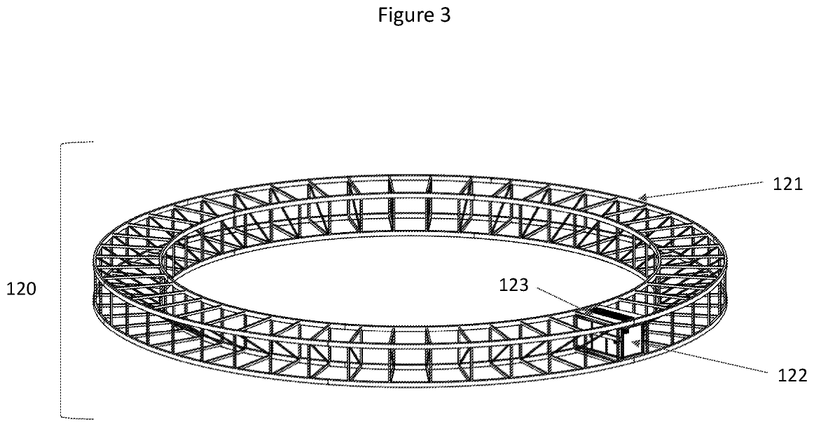

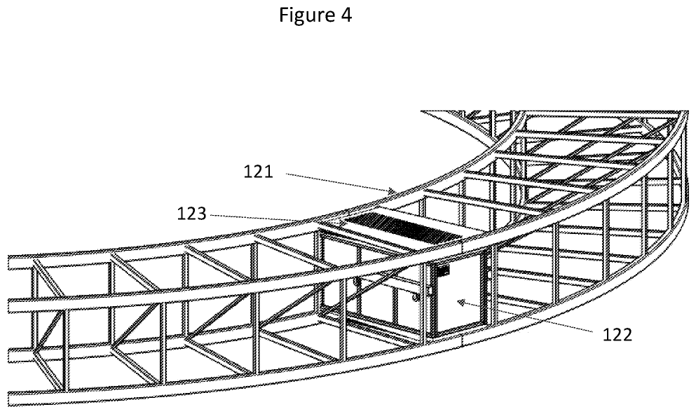

With reference to FIGS. 3 and 4, the rotating assembly 120 with most of sorbent vessels 122 removed is shown. A toroidal support structure 121 is made of a plurality of segments which can be assembled in the field. Toroidal support structure 121 guides the motion of sorbent vessel 122 and portions of sliding valve elements. Toroidal support structure 121 can be made from a plurality of frame trusses which form a continuous toroid with multiple voids for receiving up to forty-eight sorbent vessels 122 and associated counter-face plates 123 and flow control elements (not shown).

More specifically shown in FIG. 4, a portion of toroidal support structure 121, sorbent vessel 122 and counter-face plates 123 are shown in greater detail. As shown, a reinforced frame can be configured or otherwise employed or used to reduce or minimize deformation of sorbent vessel 122 during operation and under operating pressure.

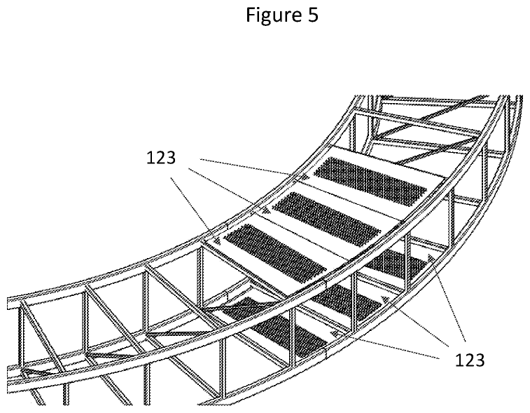

Referring to FIG. 5, several discrete counter-face plates 123 positioned adjacent to each other can form a semi-continuous surface against which seal-faces slide. A set of a plurality of openings or perforations across counter-face plate 123 for one or more passages allows a product stream to flow through the counter-face plate for fluidly connecting a sorbent vessel and a duct. A space located between passages of two adjacent counter-face plate 123 overlap with seal elements which are located on the static side of a sealing assembly (not shown) for preventing cross flow between the passages of two adjacent counter-face plate 123 which can be exposed to different fluid streams. Mounting details and sorbent vessel 122 are not shown in FIG. 5 for simplicity.

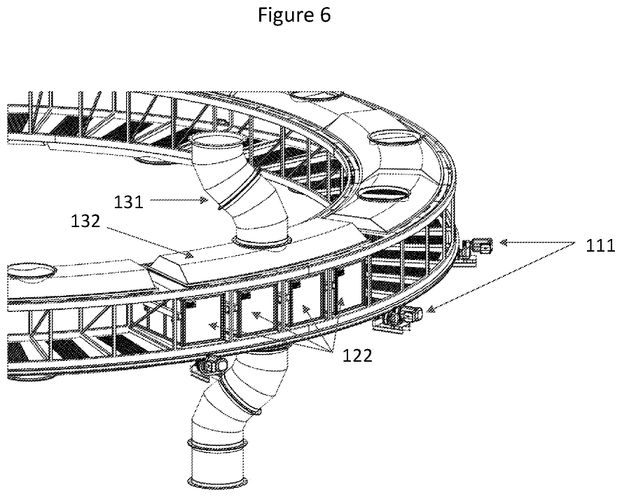

Shown in FIG. 6, a set of ducts 131 and diffusers 132 are fluidly connected to each of the sorbent vessels for distributing a flow of a fluid stream to or from each of the plurality of sorbent vessels 122. Seal-faces and associated mounting elements are not shown. Diffusers 132 is configured and sized to cover or enclose a plurality of openings fluidly connected to sorbent vessel 122 and seal-faces. In some embodiments, additional spacing elements (not shown in FIG. 6) can be placed between adjacent diffusers 132 to increase the width of a seal-face surface as needed.

As shown, it should be noted that multiple sorbent vessels 122 can be simultaneously in fluid contact with one common duct diffuser 131 and therefore one common process stream. In embodiments, multiple diffusers can be connected to a common process stream in order to increase the number of sorbent vessels in contact with a stream while using prefabricated repeated elements in the assembly of the stator side stream distribution system. This is particularly advantageous when various configurations of streams are desired in different separation applications. This enables or otherwise allows flow streams between inlet and outlet ducts to be substantially interrupted during operation of the device and rotation of the toroid, rotor, or rotating assembly.

In selected locations, to prevent cross flow leaks between adjacent inlet or outlet streams of different composition, pressure or temperature, radial seal elements (omitted in FIG. 6 but gaps between diffusers to place radial seal elements are shown) can be affixed to the stator assembly between diffusers or duct connectors.

A radial seal span can be greater than a span of a stator seal face opening and preferably equal or greater to 360 degrees divided by the number of seal face openings and their span runs between the inner diameter wear elements and outer diameter wear elements.

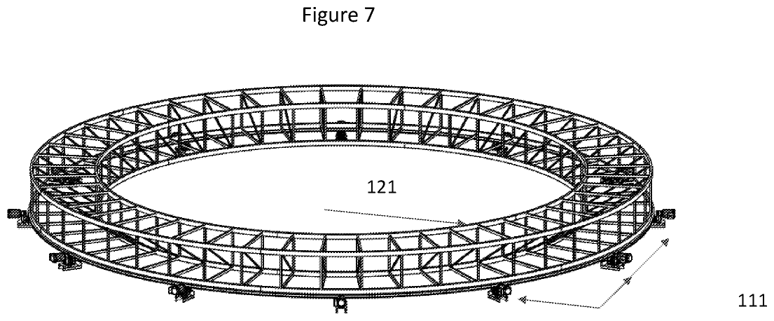

With reference to FIG. 7, a toroidal support structure 121, for supporting and guiding sorbent vessels is shown. As shown, in embodiments, a plurality of motors and driving wheels can be circumferentially and equally distributed around the toroidal support structure 121 to move the toroidal support structure 121. Even spacing or distribution of the motors reduces reaction forces within the toroidal support structure 121 and reduces excessive deformation from motive forces applied.

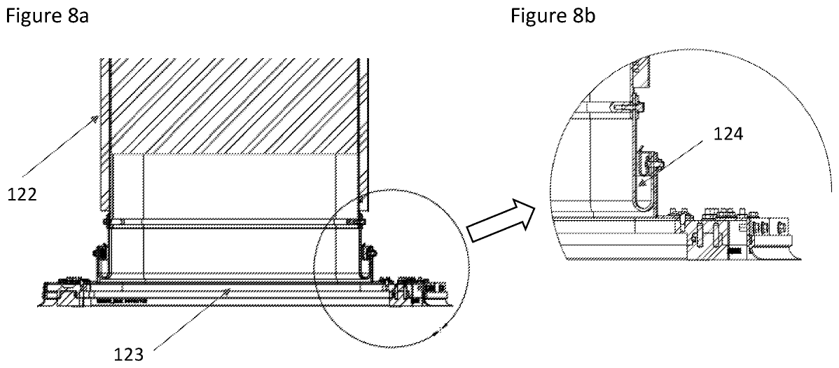

As shown in FIGS. 8a and 8b, a connector 124 can be located between sorbent vessel 122 and counter-face plate 123. Connector 124 can comprise a “U” shaped element which enables movement in a vertical direction or a direction along an axis of a flow of a fluid stream for either sorbent vessel 122 or counter-face plate 123, while maintaining a pressure boundary for a process stream or a product stream flowing to or from sorbent vessel 122. The flexibility and movement of connector 124 is desired to accommodate thermal expansion of sorbent vessel 123, as well as forces applied on sorbent vessel 122 in the vertical direction, or the direction along the axis of the flow of a fluid stream, while maintaining a desired position of counter-face plate 123.

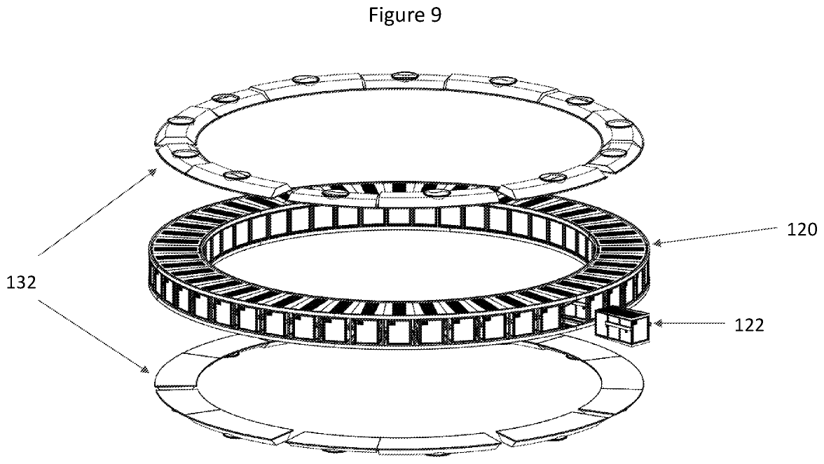

Referring to FIG. 9, a toroidal support structure 120, sorbent vessels 122 and a plurality of diffusers 132 is shown in greater detail. The plurality of diffusers 132 configured above and below toroidal support structure 120 are mirrored in this example but need not be. For some gas separation processes, it may be desirable to have one or more product streams configured and combined in a manner which is different from the process stream.

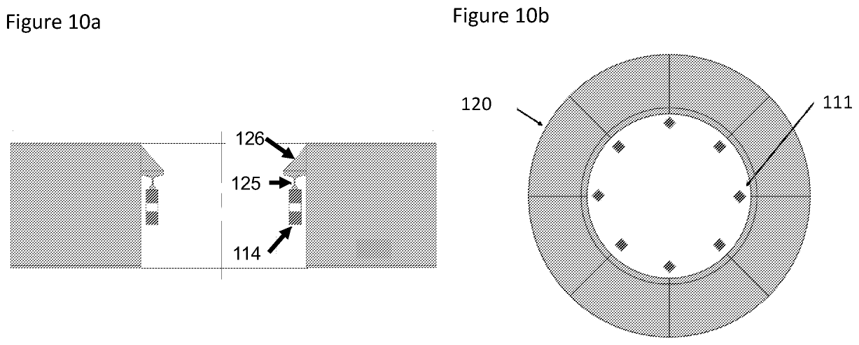

FIG. 10a shows a sorptive gas separator comprising a rotating assembly 120 in a shape of a toroid, one or more protrusions 126 located on and/or attached substantially to an inner diameter of the toroid or rotating assembly 120, a rail 125 in a shape of a circle, and a plurality of drive wheels 114 for transferring a motive force to rotating assembly 120 via the rail 125 and one or more protrusions 126. The one or more protrusions can be a cantilever but may be any suitable configuration and/or shape, and bears at least a portion of the weight of rotating assembly 120. In embodiments, each drive wheel 114 can be attached and/or coupled to a drive motor, for example, an electric motor, a hydraulic motor, or any other suitable driving means. The plurality of drive wheels 114 supports at least a portion of the weight of the rotating assembly 120.

A sorptive gas separator configured with a rotating assembly in a shape of a toroid, with substantially flat surfaces, on the top and bottom of the toroid, that can be used as sliding seal faces, and with ducts for conveying gasses to and from the sorptive gas separator substantially parallel to the rotational axis of the rotating assembly, and with the drive mechanisms substantially within the inner diameter of the rotating assembly, offers the advantages of reducing the number of components for bearing the weight and driving of the rotating assembly located on an outer perimeter or outer diameter of the rotating assembly and sorptive gas separator. This creates a substantially open access to the space inside of the toroid along the outer diameter or perimeter of the rotating assembly enabling the sorbent vessels to be easily and rapidly removed from and installed in the rotating assembly, thereby reducing maintenance downtime and costs. In one aspect, a sorptive gas separator can comprise eight or more drive wheels.

With reference to FIG. 10b, locations of the drive assemblies 111 relative to the rotating assembly 120 is shown for a rotating assembly 120, such as a toroid structure that is supported by a rail 125 cantilevered from the inner diameter (ID) of the rotor driven and supported by eight wheels, where each wheel is coupled to and driven with independent motors.

Although not shown, a gas stream can be introduced from a top and or a bottom face of the rotor with no fixed structural element interfering with access from the top and bottom faces of the toroid. The distributing motors enables bracing and support of the toroid structure at or within the ID of the toroid. In contradistinction to known systems of the prior art, rotors driven by a single shaft rotating around an axis have at least one of their stator assemblies substantially supported from the OD. In configurations where a rotor rotates around and is supported by a single shaft, the length of the rotating elements in the radial direction is less than 3 meters, greatly minimizing the amount of metal sagging and deforming at the OD.

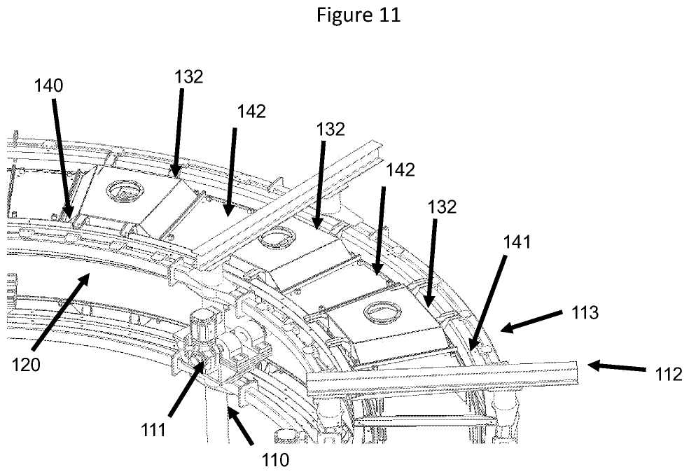

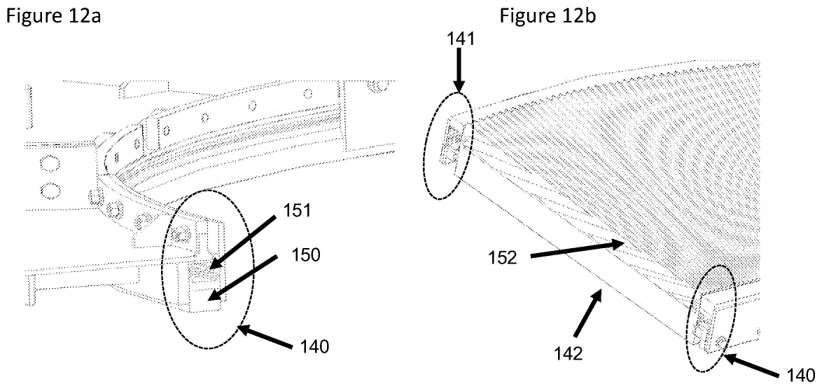

FIG. 11 shows a portion of the stator assembly and the structural support transmitting the load to the ground. The rotating assembly 120 is shown as well as a drive assembly 111 including a motor and a wheel attached to a support column 110. A structural support bridge 112 is used to locate and transfer forces to support column 110. The upper multi-stream selector valve stator assembly is configured in this example with alternating radial seal assemblies 142 and duct transition or diffuser elements 132. The combination of the toroid rotor, the ducting and the stator side seal assemblies form the multi-stream selector valve. The location of an ID seal assembly 140 and OD seal assembly 141 for holding the wearable seal elements are shown in FIGS. 12a and 12b. A holder of a wearable seal is configured in the form of a curve groove securing the wearable seal element restricting its motion in the radial direction while allowing the wearable seal element to move vertically or in the direction of the axis of rotation. Further detail of an exemplary embodiment are provided in FIGS. 12a and 12b.

FIG. 12a shows a cut out of ID seal assembly 140 with the wearable and flexible seal element 150 energized and urged toward the rotating seal face by an inflatable bladder 151. These two elements are guided by a groove that can be an extruded single piece or an assembly of multiple components. FIG. 12b shows a side facing the rotating seal face of a radial seal. A plurality of wiper seals 152 can be attached to a solid plate bridging the gap between the ID seal assembly 140 and OD seal assembly 141. With multiple wiper seal element energized simultaneously when pressed against the motive seal face surface between flow openings. In an embodiment, the differential pressure experienced by each wiper seal is only a fraction of the total pressure difference between the adjacent process streams.

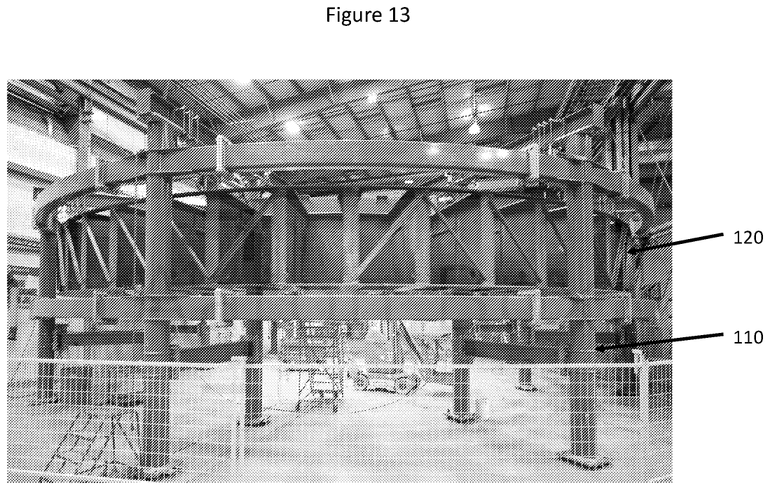

In FIG. 13, an exemplary sorptive separation machine (see Example 1) before the installation of the duct and duct connectors as well as installation of the sorbent vessels is shown. The toroid 120 is supported by 8 motorized wheels on the inner diameter of toroid attached to a rail connected by a cantilever. The inner diameter of the structure is about 10 meters while the outer diameter is about 14 meters. The rotating toroid 120 presents openings on the outer diameter face of the toroid to allow the insertion of placement of the plurality of sorbent vessels therein. A top opening in the seal face can also be observed from this angle on a top annulus. The support structure for the separator is distributed equidistantly and circumferentially every 45 degrees using a set of columns 110 straddling the toroid 120.

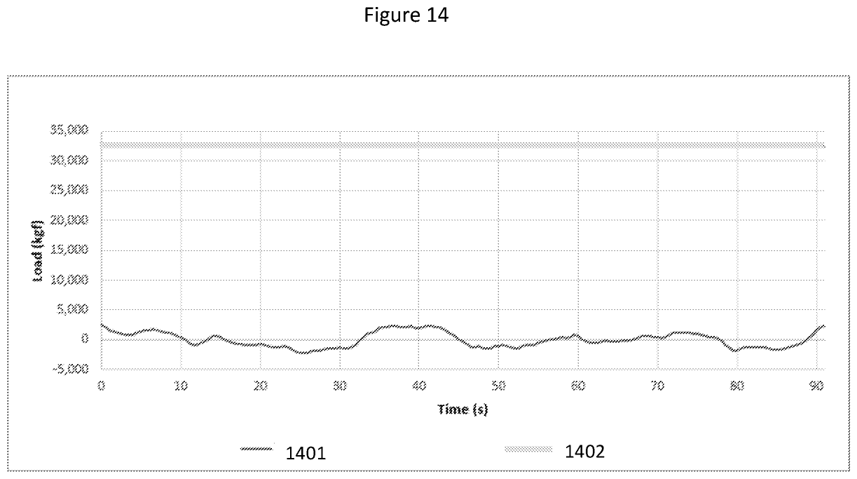

FIG. 14 illustrates the variation versus time of vertical reacting load measured at 1 of the 8 support wheels shown as a plot 1401 in kg of force when an approximatively 33,000 kg toroid shown as a plot 1402 with approximatively 10 m inner diameter and 14 meter outer diameter is being spun at 1 rpm around a vertical axis of rotation. There is always some load on the wheel instrumented to record vertical forces with a range of force variation of about +2,000 kg force versus an expected average value of about 4,000 kg force. The toroid in this example was spun using one single motive wheel. As shown, the variation of vertical load had no impact of the friction drive performance while the vertical positioning of the seal faces (one on top and one on the bottom) was maintained with a 2,000 micron per meter of length motion along the circular trajectory and a 10,000 micron of vertical motion range for one full rotation.

As the toroid in this example was not loaded with sorbent vessel and filled with sorbent and not reacting to stream head losses, the total vertical load when in operation is expected to between 80,000 kg force and 120,000 kg force or 10,000 kg force to 15,000 kg force per wheel enabling friction traction with 8 motive wheels to transmit a total torque in the range of 1,000 Nm to 4,000,000 Nm.

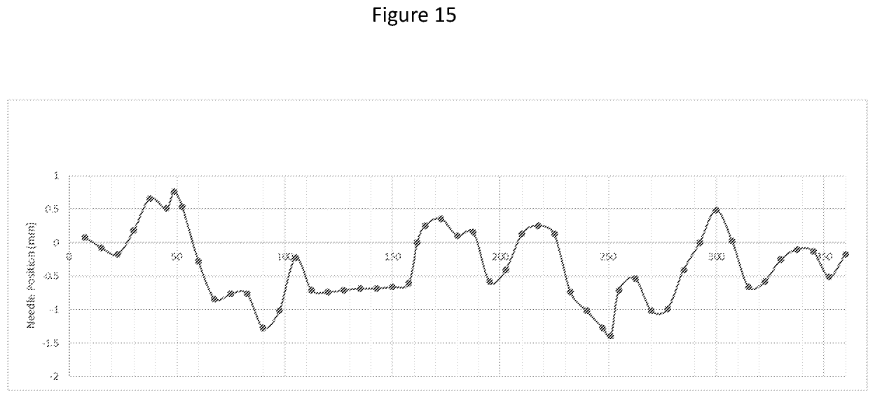

FIG. 15 illustrates the variation in elevation along on circular line of contact at the bottom seal face of the toroid of Example 1, measured with a gauge in a fixed location about 7 meters away for the center of rotation while the toroid of Example 1 is rotated around a vertical axis versus angle of rotation of the toroid. As shown, the range of vertical position is within ±1 mm for most of the rotation and with ±1.5 mm for the whole rotation. This satisfies the target of less than 10,000 micron or 10 mm of total elevation variation for a full rotation as well the target slope of less than 2,000 micron per meter of displacement. At this location near the OD of the toroid, 10 degrees of rotation is equivalent to about 1.2 meter of linear displacement along the rotation circle.

In the design of a large scale sorptive gas separator, various approaches to resolve the challenge of moving with precision, large volumes of solid sorbents (including, for example, an unsupported solid sorbent, a supported solid sorbent, a solid sorbent disposed in a sorbent structure, a sorbent contactor or a parallel passage contactor) affixed to a common seal face or sliding seal face were considered. The solution must enable the sorbent to come into contact with different process gas streams introduced at different fixed or stationary locations.

Developments made towards addressing these problems are described below.

The proposed solution in the design of a large sorptive gas separator, with modest movement resistance and a modest number of feed and product stream connections is to depart from a cylindrical shaped sorptive gas separator comprising a rotor supported on a central shaft rotating around an axis. A preferred alternative sorptive gas separator design comprises a plurality of moving vessels, with each moving vessel enclosing solid sorbents affixed to a substantially rigid torus or toroid.

The plurality of moving vessels combine to form a rotor where the rotor comprises at least one of a seal face or a sliding seal face part of at least one sliding valve mechanism.

The novel structure disclosed herein differs from large volume sorbent-containing structures known in the art for capture of CO₂ from air, known as “direct air capture” (herein referred to as “DAC”) machines, as those machines do not comprise a continuous seal or sliding face on a rotor. In DAC machines, which typically have only two to three process steps, sorbents are not required to be isolated from the ambient environment (ambient air) for the majority of the process cycle, therefore no seals are required to contain and direct air through the sorbent bed for the majority of the process and motion of the sorbent beds. Further, another point of contrary distinction is in the motion of the sorbent beds, which is indexed, rather than continuous.

For a CO₂ emission abatement application from an industrial process gas process, a short cycle time is desired which at larger scales and masses is not compatible with indexed motion having frequent and rapid acceleration and deceleration motions. The much larger productivity in metric tons (MT) of CO₂ per cubic meter (m³) of sorbent contactor per day (greater than 2 up to 40 MT of CO₂ per m³ of sorbent) and differences in pressure drop across sorbent contactors in the CO₂ emission abatement application from an industrial process gas process relative to DAC applications result in highly differentiated processes and machine design requirements.

In an embodiment, the sorption gas separation machine can include a multi-stream selector valve comprising a rotating toroid attached to at least one circular rail supported by a set of wheels placed in fixed positions and distributed at angular increments to contact the rail simultaneously. The wheels can provide both reacting forces to the static load of the toroid and at least one wheel can provide a motive force for rotating the toroid, without being driven or supported by a central shaft. At least one face of the toroid is essentially flat or in a shape of a frustum of a cone and which is used as an interface for a sliding seal or seal face integrated in a multi-stream selector valve, a set of ducts and duct connectors, a support structure for the drive and wheels supporting the toroid as well as positioning the set of ducts and duct connectors forming a stator assembly, seal assemblies including flexible wearable seal components in contact with the moving toroid and subject to friction.

The central shaft support and drive structure known in the art, requires excessive rigidity to precisely position seal face(s) and is therefore undesirable for the degree of seal performance desired in such gas separation applications. As the key function supported by the toroid design is contacting fluid or gas streams through a multi-stream selector valve to a moving sorbent bed, this innovation applies equally to multi-stream selector valves and sorption separation machines.

In an embodiment, a rotating toroid can be attached to at least one circular rail supported by a set of wheels placed in fixed positions and distributed at angular increments to contact the rail simultaneously, the wheels providing both reacting forces to the static load of the toroid and at least one wheel providing a motive force to rotate the toroid, without being driven or supported by a central shaft. Wherein at least one face of the toroid is essentially flat or in a shape of a frustum of a cone and which is used as an interface for a sliding seal or seal face integrated in sorption separation machine or a multi-stream selector valve.

In an embodiment of a sorptive gas separator for non-DAC applications, such as, industrial gas separation applications, a desired length of the flow path between an inlet and an outlet of a sorbent contactor can be between about 0.5 m to 2 m. In an embodiment, a toroid thickness or flow path length measured along a direction of an axis of rotation can be between 0.5 to 2.5 meters. In embodiments, the toroid can be an assembly of toroid segments positioned and attached to form a rigid toroid.

The flow path length is driven by the desired high capture efficiency of greater than 90% or preferably greater than 95% for CO₂ recovery from the process or flue gas. With the flow path length constraint, the simplest shape for the sorbent vessel which enclose one or more sorbent contactors can be a cylinder of 0.5 m to 2 m length. While a cylindric shape is advantageous for directing and confining pressurized gas, filling up a torus with cylinders does not lead to the effective space utilization of the torus volume.

In an embodiment, a plurality of sorbent vessels can be affixed or, otherwise attached, to a rotor of a sorptive gas separator, and located in a torus or toroid. In an embodiment the toroid can have a shape generated by rotating a rectangular prism or a trapezoid prism about an axis of rotation. In an alternative embodiment, the torus or toroid can have a shape such as that generated by rotating a closed loop, such as, an ellipse or a circle, about an axis of rotation.

In an embodiment, each of the plurality of vessels can enclose at least one sorbent and/or sorbent contactor, and can be adapted or configured to have a cross-sectional shape substantially the same as a cross-sectional shape of a rotor or toroid, and/or configured with a rectangular prism cross-sectional shape with an aspect ratio between any two dimensions, for example, a height, a length or depth, or a width of the rectangular prism where the aspect ratio is between about 0.4 to about 2.5.

In other embodiments of a sorptive gas separator, the plurality of vessels can be operated with a modest pressure differential, for example, less than about 100 kPa, between the surrounding or ambient environment external to the vessels, and the process gas flowing through or internal to the vessels. Rectangular prism cross-sectional shaped vessels can have spans of up to about 2.5 m to facilitate transport and installation into the sorptive gas separator. The path and/or a track on which the vessels convey can be selected to increase a sorbent density relative to the total footprint of a sorptive gas separator thereby increasing the utilization of the footprint or space of the sorptive gas separator. For example, greater than about 60% of the footprint of a path of the vessels can be occupied by the plurality of vessels.

In some applications, such as retrofit applications, an available space to install a new sorptive gas separator in close proximity to an existing flue gas source is limited. Therefore, a sorptive gas separator which is smaller in volume and/or footprint is not only a more economical machine but also a machine that is compatible with existing chemical plant layouts or industrial plant layouts.

In another embodiment of a sorptive gas separator, a path or a loop of vessels can be configured in, for example, an obround, an ellipse, an oblong, a circle, an oval, or any combination thereof, or any other suitable shape. In this configuration, preferably the internal area and external area inscribed by the motion or path of the vessels and associated structure for sealing and positioning of the vessels is such that the total footprint of the sorptive gas separator is less than about 170% of the vessel path and associated sealing structure area in the direction perpendicular to a horizontal plane of the sorptive gas separator.

Table 1 provides sample dimensions and other parameters of an embodiment of a sorptive gas separator having 48 vessels, where the plurality of vessels are arranged in a circle and are configured to travel in a circular path, where the vessels are distributed substantially evenly around the circle with a central angle of 7.5 degrees.

TABLE 1
ID and OD relation for a track containing 35 m² of rectangular
vessel face in 48 vessels with 0.15 m between vessel corners
at an ID cord with loop packing density values.

| Rotor ID @ | | | | | | | |
|---|---|---|---|---|---|---|---|
| Structured | Bed | | Bed | Bed | | | |
| Adsorbent | face | | radial | Aspect | | Loop | |
| Bed Face | arc | Bed | stack | ratio | Rotor | Packing | |
| (vessel) | length | width | height | (H/W) | OD | density | Span |
| m | mm | mm | mm | | m | | m |
| 6 | 222.7 | 220 | 3338.7 | 15.2 | 12.7 | 35.8% | 3.349 |
| 7 | 288.1 | 280 | 2623.2 | 9.4 | 12.3 | 44.2% | 2.634 |
| 8 | 353.6 | 350 | 2098.6 | 6.0 | 12.2 | 52.6% | 2.109 |
| 9 | 419.0 | 410 | 1791.5 | 4.4 | 12.6 | 57.7% | 1.802 |
| 10 | 484.5 | 480 | 1530.2 | 3.2 | 13.1 | 63.1% | 1.541 |
| 11 | 549.9 | 540 | 1360.2 | 2.5 | 13.7 | 66.2% | 1.371 |
| 12 | 615.4 | 610 | 1204.1 | 2.0 | 14.4 | 69.9% | 1.215 |
| 13 | 680.8 | 680 | 1080.2 | 1.6 | 15.2 | 73.0% | 1.091 |
| 14 | 746.3 | 740 | 992.6 | 1.3 | 16.0 | 74.6% | 1.003 |
| 15 | 811.7 | 810 | 906.8 | 1.1 | 16.8 | 76.9% | 0.917 |
| 16 | 877.2 | 870 | 844.3 | 1.0 | 17.7 | 77.9% | 0.855 |
| 17 | 942.6 | 940 | 781.4 | 0.8 | 18.6 | 79.6% | 0.792 |
| 18 | 1008.1 | 1000 | 734.5 | 0.7 | 19.5 | 80.4% | 0.745 |

A sorptive gas separator configured with a substantially circular looped path having a larger inner diameter can achieve a greater fraction of coverage of a vessel path area by increasing the total sorbent volume of the vessels resulting in an increase in density of the sorbents relative to the footprint of the sorptive gas separator. The increased density of the sorbents and vessel may also result in reducing the amount of structural support and machinery needed to guide the motion of the vessels around the track.

In embodiments, a sorptive gas separator and process can operate where the plurality of vessels are conveyed or otherwise moved around a looped path in a substantially continuous motion, rather than in discrete steps, for example, indexing, with distinct starts and stops at different locations or process stations corresponding to different process steps.

Indexed motion of vessels through discrete steps while advantageous for creating high quality seals at critical times, require individual beds to be moved independently and additional buffer volumes of sorbents and vessels in order to allow for a portion of the vessel to move continuously without running into stationary vessels which would likely require complex multi-axis robots. Index motion enable the use of seals that are not sliding seals.

Because of this, sorptive gas separators and processes having substantially continuous motion, optionally with a substantially constant rate of motion during normal operation, are highly desirable for applications involving gas separation applications from, for example, an industrial process gas or a combustion gas. The use of continuous motion for vessels along a looped path is a feature of embodiments of the gas separation processes and sorptive gas separators disclosed herein. In contrast, DAC processes and machines generally employ indexed and non-continuous motion machines and process steps.

In embodiments, sorptive gas separators and processes comprise a motive or dynamic structure (also referred to as a rotor), and a stationary or a static structure (also referred to as a stator). The moving or dynamic structure can comprise: a plurality of vessels, in each of which the solid sorbents and/or sorbent contactors are disposed therein, and through which a process gas is allowed to flow; a connecting structure, such as a support frame for supporting and guiding the vessels; and motive counter-face plates or segments for forming a portion of at least one multi-stream selector valve.

The static structure can comprise: a duct having a conduit and a duct connector or diffuser; a structural support element for supporting and positioning the ducts; and a plurality of stationary seal-faces for forming another portion of the at least one multi-stream selector valve.

In embodiments, a sorptive gas separator can be configured with seal-faces on the motive or dynamic structure and counter-faces or counter-face plates on the stationary or static structure.

In an embodiment, the rotating toroid can have a substantially vertical axis of rotation, where the wheels are evenly distributed along a circumference of the toroid, with motors attached to at least two wheels, with at least 4 support wheels for a 4 meter inner diameter (ID) toroid, at least 8 support wheels for a 10 meter inner diameter diameter toroid, at least 12 support wheels for a 20 meter inner diameter toroid and 16 support wheels for a 30 meter inner diameter toroid.

Applicant has found that these configurations limit the span between sets of wheels and the amount of vertical force applied to each wheel.

In an embodiment, the rotating toroid can be formed of at least 4 toroid segments which are connected, combined or otherwise attached to one another, to create a full 360 degrees toroid having at least 16 enclosures with attachment features to affix one vessel in each enclosure.

In an embodiment, the toroid can have at least one seal face comprising a plurality of openings to enable fluid flow across the seal face with the sum of the surface area of said opening being at least 30% of the said seal face area and at most 90% of said seal face area.

In an embodiment, the toroid can have two opposing seal faces, wherein openings in the opposing seal faces are a mirror image of one another.

In an embodiment, a sorptive gas separator, for separating a first component from a multi-component fluid stream, can comprise a toroid of the present invention, a plurality of vessels housing a selective sorbent material for sorbing the first component from the multi-component stream, at least one stator side seal assembly including duct connectors, inner and outer perimeter seals and radial seals, a plurality of motors for transferring a motive force to the toroid and a first process stream duct, such as a feed stream duct, for directing said multi-component fluid stream as a feed stream to said plurality of said vessels, wherein said feed stream duct is substantially stationary, a first product stream duct for directing a first product stream recovered from said plurality of said vessels, wherein said first product stream duct is substantially stationary, a second process stream duct such as a first regeneration stream duct for directing a first regeneration stream to said plurality of said vessels, wherein said first regeneration stream duct is substantially stationary, and a second product stream duct for directing a second product stream recovered from said plurality of said vessels, where said second product stream duct is substantially stationary.

In an embodiment, the toroid can have two seal faces, each located on opposite faces, wherein each seal face is in contact with a stator seal system with duct connectors and gas distribution connecting inlet and outlet ducts across vessels affixed to the toroid.

In an embodiment, the sorptive gas separator can be connected to stream ducts that are rated and sized to direct the process streams at a pressure equal to or less than 100 kPa (g).

In embodiments, a sorptive gas separator can be formed from pieces or components of a machine that are sized to be transported on a truck such as a flatbed truck with a maximum dimension of 12 m length, 2.9 m height and 2.4 m width. The toroid structure supporting the plurality of vessels can have a weight that is less than twice the combined weight of the plurality of vessels loaded with sorbent affixed to the toroid.

In an embodiment, a force applied on the toroid by the process stream head losses across the sorbent contactors or vessels can be less than 20,000 Pa in a direction of the flow, and preferably less than 10,000 Pa.

Embodiments of the invention can be used to support rotors shaped in a toroid having outer diameters (OD) ranging from 1 m to 50 m or particularly between 5m to 50 m, with self-weights (total weight of a rotor with vessels and sorbents, excluding forces from the flow of gasses) from about 5 to 130 metric tons. A preferred embodiment a rotor in a shape of a toroid is 15 m OD×11 m inner diameter (ID)×1.4m high, with a self weight of 30 metric tons, and can carry an additional 30-100 metric tons of external loading (additional force applied in addition to self-weight).

In an embodiment, the rotor shaped in a toroid can have an aspect ratio relating the outer diameter (OD) to the inner diameter (ID) ranging from 1.1 to 1.5. Above a ratio of 1.5, the structural efficiency gained by leveraging hoop stress diminishes. Below a ratio of 1.1, there is a reduction in useable, functional working volume and surfaces versus required open area to field the device as well as the seal element length. In an embodiment, the aspect ratio can be about 1.3. In another example, the ratio can be proximal to 1.2.

One aspect specific to a distributed bearing and traction system is that the power requirements for such a traction system are the product of torque and speed. The torque required can likely be proportionally linked to a pitch diameter (average of ID and OD), plus any number of external loads brought onto the rotor by the nature of the application. In an embodiment, a rotary gas switching valve can have seals exerting pressure onto rotor surfaces, creating a rotary drag which must be overcome to maintain rotary motion. The range of torque required can range from about 1000 Nm to about 4,000,000 Nm. In embodiments, the system can be sized for 500,000 Nm, while in other embodiments, the system can be sized for 1,800,000 Nm.

A rotational speed of the toroid can be variable, ranging from 0.5 rpm to 10 rpm. In embodiments, the rotational speed can be in a range of 0.5-2.5 rpm. The application can make use of variable frequency electric motor drives to enable continuous or non-continuous speed control. Applicant believes that there does not appear to be any theoretical limit to the maximum potential rotational speed embodiments of the invention can use. But, at higher rotational speeds, notional loads induced by rotor dynamics can become non-trivial and exceed practical limitations of structural housing or support.

An operative temperature range can be between about −40° C. to 50° C. ambient temperature, subject to proper material selection and impact toughness. In embodiments, the rotor can be constructed of steel or stainless steel and can withstand local temperature excursions to 130° C. Temperature analysis can have a significant role in the design of such radially cantilevered rotors or distributed bearing and traction systems, as it can impose limits on strength, toughness, and geometric accuracy.

In an embodiment, radially cantilevered rotors or distributed bearing and traction systems can achieve axial runouts of 2.4 mm on a 15 m OD rotor of 30 metric tons, including all manufacturing tolerances and deflections due to self-weight. By comparison, a sample of a manufactured 4 m OD rotor on a traditional central slewing bearing achieved only a 4 mm axial runout.

In the process of de-coupling from traditional and commercially available monolithic bearing raceways into multiple distributed support locations, an entire order of magnitude of rotor sizes can be enabled since each rolling element (as traditionally referred to in bearing technology) can itself be mounted on a shaft and supported by traditional roller bearings rated for a fraction of the original load. This arrangement provided by the plurality of distributed support rollers provides improved ability to predictively calculate reliability and enables faster replacement times in the event spares or replacements are required. In an example, a standard L10 bearing reliability was used to ensure that fewer than 10% of bearings will fail prior to reaching their full-service life.

In an embodiment, the toroid can be rotated about a central axis at a substantially constant rotational speed. In an embodiment, the rotational speed of the toroid can be between 0.5 rpm and 10 rpm.

### Seal Design

Stationary seal elements work cooperatively and in conjunction with a motive or rotating seal face. The stationary seal can physically be in contact with the rotating seal face for forming a perimeter seal therebetween and fluidly isolating each process or product stream. In embodiments, a portion of the perimeter seals with radial seals about a sorbent vessel, fluidly isolates the sorbent vessel and directs fluid through openings in a motive seal face associated with each of the plurality of sorbent vessel to fluidly connect each of the plurality of sorbent vessels to the separator.

Stationary seal-faces can contain materials suitable for permitting or otherwise allowing slippage with low static and sliding friction coefficients against a corresponding motive counter-face plates or elements, such as polytetrafluoroethylene (herein referred to as “PTFE” or “Teflon”) or PTFE-filled composites including or fluorinated copolymer for example PolyVinyl DiFluoride (PVDF), and can be configured as and/or with sliding seals, brush seals, wiper seals, or a combination thereof.

In an embodiment, ID and OD perimeter seal assemblies can comprise a seal ring having multiple or a plurality of segments with at least one wear element that is flexible, free to move in a direction parallel to the rotation axis and pressed against the motive seal face for maintaining continuous contact with and between the motive seal face and the static side seal ring. The seal ring can be made of multiple segments that can easily be assembled on site as large machines need to be field erected.

Radial seal elements, that can be configured to isolate set annular segments, isolates and otherwise prevents cross leaks between adjacent sorbent vessels and process streams providing a high degree of flexibility in creating different process sequences experienced by the rotating sorbent vessels. Specifically, the present seal system is modular and scalable to large sizes while maintaining a low leak rate and an extended service life. In particular, the present seal system is designed to operate on rotary machines, such as sorptive gas separators or other gas separation systems, with a diameter of up to 50 meters. The leak rate achieved by embodiments of the invention described herein measured under a differential pressure of 50 kPag, was less than 10 liters STP per minute and per meter of linear seal length with a steel counter-face roughness exceeding 0.5 microns Root Mean Square (RMS) or more preferably greater than 1.0 micron RMS. This is a considerable improvement in the ability to maintain a low leak rate even with a counter-face roughness of several orders of magnitude worse than is typical in the prior art.

The requirements for flatness or evenness of the seal surface is reduced by the ability to have part of the seal system conform to the imperfection in manufacturing of a large toroid seal face. Additionally, seal wear is accommodated by the flexibility of the seal wear elements combined with the actuation system distributing an even force to the opposite side to the sliding contact side of the wearable seal element.

While the ID and OD perimeter seal assemblies constrain the motion of the wearable seal element in a radial direction, the wearable seal can move in a direction of the axis of rotation of the seal or a circumferential direction.

An energizing or urging element can be integrated in the ID or OD perimeter seal assembly, and can be secured to prevent spin, but is free to grow in the rotational axis direction of the toroid or circumferential direction.

Referring back to FIG. 11, in an embodiment, a seal system comprises an ID perimeter seal 140, an OD perimeter seal 141, and a plurality of radial seal assemblies 142 for separating and preventing mixing of different gas streams introduced through duct connectors 132 to the seal face and seal face opening connecting fluidly to each sorbent vessel affixed to a rotating assembly 120, or otherwise isolating each of the plurality of sorbent vessels from one another.

In embodiments, a sorptive gas separator can have a multi-stream selector valve wherein the seal system (motive seal face, ID and OD seals and radial seal assemblies) comprise a seal face on the toroid and a seal assembly on the stator side for providing a seal function characterized by the maximum amount of leakage allowed (e.g. less than 1% of the influent flow (incoming process gas flow) or more preferably less than 0.1% of the influent flow). As the toroid or rotating assembly 120 rotates, the seal face remains in contact with the stator at a fix angular position on the stator side, and can move in a rotation axis direction due to imperfections of the toroid fabrication, deflection of the toroid under mechanical load, and thermal growth of the toroid induced deformation. In order to accommodate for this fact, the stator side seal assembly (ID and OD seals, radial seal assemblies) can be flexible and urged towards the seal face. For a large machine with an outer diameter of about 15 meters, the flexible seal wearable elements on the stator side are designed to accommodate up to a pitch (the variation in height of the rotating toroid at a fix radial distance from the center of rotation) of up to 2,000 microns per meter of displacement on the seal face of the toroid through rotation and as much as 10,000 microns per full revolution of the toroid. This is achieved by applying multi-segment wearable seal elements that can move independently unto which distributed force is applied using an inflatable bladder, taking the shape of a rotary seal face on the toroid. A requirement of flatness is no longer limited to a typical maximum seal face slope (or pitch) of 1 micron per meter as in the conventional contact seals of the prior art. As the size of a selector valve or toroidal shaped sorptive gas separator increases in diameter, this flatness constraint can be further relaxed with a maximum pitch limited by the flexibility of the wearable seal element and the inflatable bladder expansion range with maximum values of 4,000 microns per meter and 20,000 microns per full revolution. With a toroidal structure, the number of support points are increased as the diameter increases.

In embodiments, the seal system can comprise at least one inflatable bladder as an energizing element or an urging force for an ID seal and/or an OD seal. The sealing force is adjusted and maintained by controlling the pressure of a fluid inside the bladder, creating a compliant seal face that can follow the rotor shape. Preferably, the fluid used in the bladder is air, but any suitable fluid may be used.

In further embodiments, the seal system can comprise radially orientated seals such as wiper seals that can limit gas leakage to less than 10 litres per minute per meter of seal circumference under 50 kPa of differential pressure for separating different gas streams in a carbon capture machine such as a sorptive gas separator and prevent gas flow from adjacent flow modules to each other. Compared to previous seals used on prior art air preheaters, the leakage rate is significantly reduced from the typical 100 to 1,000 litres/minute per meter.

To ensure proper function, a the distribution of openings in the seal face of the toroid requires a sufficient area which is flat in the case of an annular shape seal face or curved smooth face in the case of a frustrum of a cone shape seal face to simultaneously engage multiple wiper seals and distribute the pressure differential from adjacent process streams to individual wiper seals. For example, if the difference of pressure between a stream A for example a multi-component feed stream and a stream B of steam stream is 40 kPa, when 10 wiper seals are providing the seal function in series (in a circumferential direction), on average the pressure differential across each wiper seal would be 4 kPa.

In an embodiment, a lower force can be applied to the radial seal assemblies due to the different seal mechanism employed, i.e., the circumference seals, are urged by the inflatable bladder while the radial seals are not. Therefore, it is expected that the wear rate of those wiper seals will significantly be lower than that of the circumferential ID and OD seals which are in continuous contact with the motive seal face. Positioning of the radial seal face can be fixed relative to the stator support structure with adjustable bolt or shimming, or can be attached to motor driven linear actuators. The use of pressure control with air-piston, for example to adjust a force applied to the wiper blade is not desirable, if significant pressure difference between the ambient pressure and the streams in contact with the radial seal plate is greater than 10 kPa, as the force toward or away from the toroid due to the pressure differential will be greater than the force applied on the seal.

An air piston can be used in combination with sliding pins or strips or wheels to control the position of the radial seal assembly versus the rotor seal face, independently from the forced applied to the wiper seals. In this case, a control pressure can be adjusted for each radial seal independently, as a function of the gas stream pressure adjacent to the radial seal. The same replacement schedule for the ID and OD perimeter seal wearable element and the radial seal wipers is envisioned at a 2 to 5 years interval.

The wear rate of the multi-segment seal material used in the inner and outer perimeter seals was measured on a test apparatus of 6-inch diameter PTFE disks in contact with a steel counter-face at a rotational rate of 180 revolution per minute (about 0.5 m/s linear velocity) with an applied compressive pressure of 5 psi (˜30 kPa) and with a surface counter-face roughness of 1-10 microns RMS. A wear rate of 8-10 microns of the PTFE seal per day of continuous operation was measured under the aforementioned test conditions. A multi-year service life for the seal wearable element can be achieved when 10 millimeters or more of wearable seal thickness can be removed while remaining within the range of motion in the rotation axial direction allowed by the inner diameter (ID) and outer diameter (OD) perimeter seal assemblies.

For example, a 50 mm tall PTFE element can be formed into a ring with an inflatable bladder allowing 20 mm of travel in the rotation axial direction. Once 10 mm of wearable seal is removed, 10 mm of travel allowance remains to compensate for motive seal pitch.

The seal system described herein provides a solution for sealing large rotary machines, and specifically carbon capture machines or other gas separation machines with improved economies of scale for larger sized units. With its modular and scalable design, it is the largest seal currently available in the industry and has unique features that distinguish it from conventional prior art sealing designs. The present invention delivers notable features as described above to achieve improved performance in sealing fluid flows, especially for those at larger scale in terms of flexibility of operation, lower energy of operation (operating cost) and the efficiency of separation of fluid streams.

In embodiments, a linear velocity of the moving counter-face or moving seal face in the sorptive gas separator can be between 0.2 to 4 meters per second.

Sorbent wheels can have a shape that is substantially a cylinder, with a small inner diameter (ID), a large outer diameter (OD). When the sorbent wheels rotate on a shaft around an axis, presents a large speed differential, proportional to the OD/ID ratio. The speed differential creates significant challenges for sliding seals, for example, a difference in wear rate of a seal surface along the outer diameter relative to a seal surface along the inner diameter, and/or different friction forces on different segments of the seal perimeter.

Embodiments of sorptive gas separators having a toroidal or loop configuration where the structure or vessels which enclose the sorbents are configured in a shape where the OD/ID ratio is small relative to, for example, a sorbent wheel configured in a shape of a cylinder with a large OD/ID ratio. This can significantly reduce the seal-face travel speed differential between components located proximal to the inner diameter relative to components located proximal to the outer diameter of a sorptive gas separator.

In embodiments, the ratio between the outer diameter of the toroid and the inner diameter of the toroid can be less than 1.5.

In embodiments, where sorbent vessels move along a looped path, a maximum velocity ratio between seal counter-faces moving at a designed maximum operating speed relative to a designed minimum operating speed can be less than 2 meters per second.

In embodiments where sorbent vessels move along a looped path, the vessel path may comprise one or more linear segments or paths connected to one or more curved segments or paths, for example, a loop path configured in a shape of an obround.

In an aspect, one or more steps of a sorptive gas separation process with the lowest allowable or desirable leakage for a process and/or a product gas stream between the stationary elements and motive elements, can be located on a segment or path which is linear, as opposed to on a curved segment or path. In another aspect, stationary elements such as ducting for the one or more steps in the sorptive gas separation process with the lowest allowable or desirable leakage for a process and/or product gas stream between the stationary elements and motive elements, can be located on a segment or path which is linear, as opposed to on a curved segment or path.

In another aspect of the invention, a gas distribution system for a sorptive gas separator comprises ducts, diffusers and a plurality of stationary seal-faces having a passage for a fluid stream, and at least one multi-stream selector valve each assembled from a plurality of discrete segments, such as, a seal-face and a motive counter-face plate. A plurality of discrete motive counter-face plates can be configured substantially adjacent to each other, to create a semi-continuous moving counter-face assembly. In embodiments, each motive counter-face plate can contact and slide against successive stationary seal-faces, where both the counter-face plate and the seal-face have a passage with a Cᵥ of equal to or greater than about 500,000, or where at least one of the counter-face plate and/or the seal-face comprise a plurality of passages which when combined provide a Cᵥ of equal to or greater than 75,000, 100,000, 250,000, 500,000, 700,000 or 1,000,000.

Such a large Cᵥ is desired to accommodate the large amount of gas flow through each seal-face, counter-face plate and individual sorbent vessel without inducing a large pressure drop.

In embodiments, a multi-stream selector valve can have a large Cᵥ, for example, equal to or greater than about 500,000, with a leak rate of less than about 2% of a flow of a process or a product gas stream during operation at designed operating conditions, and/or is made of repeated segments that can be easily manufactured, transported and assembled at an operating site. In some embodiments, the leak rates on critical steps of a gas separation process, such as recovery of a purified product stream or recovery of a second product stream, can be less than about 0.5% and preferably less than about 0.25% of the flow of the purified product stream or a second product stream.

In embodiments, the multi-stream selector valve has a sum of inlet flows and a sum of outlet flows that are substantially equal i.e., less than 2% difference, over the period of a full rotation of the toroid.

In embodiments, moving counter-face elements can comprise a plurality of plates for creating or forming a passage by being placed adjacent to and aligned to one another. A flexible or rigid fluid connector can be attached to one side of one or more counter-face plates and to one side of a sorbent vessel. The connector can guide a gas stream, such as a product stream or a process stream to flow from the multi-selector valve to an appropriate sorbent vessel.

Counter-face plates can be attached to a supporting structure of the vessels, such as a support frame, or to the supporting structure of the static gas distribution ducting or piping elements. In the latter case, the counter-face plates can be driven through guiding pins from the moving structure.

A seal-face can slidably mate with a counter-face element or plate where both the seal-face and counter-face plate can work cooperatively to provide a seal perimeter between contact elements and the sliding surface with equal to or less than about 0.2 millimeters of clearance or preferably, equal to or less than about 0.1 millimeters. Gaps at joints between adjacent elements, for example, adjacent seal-faces or adjacent counter-face elements, can be reduced or minimized so that there is only a low leak rate at the perimeter of the wetted flow volume through the multi-stream selector valve. Adjacent elements can be fit into each in a “tongue and groove” configuration to reduce or largely eliminate any leakage along the joint between adjacent elements. As designing a large machine with tight compliances is difficult, control of the relative positioning of a seal-face and a counter-face plate is controlled locally for each individual segment through any suitable urging means for applying a controlled amount of force to drive and/or move at least one of the seal-face or the counter-face plate towards one another.

As multi-stream selector valves integrated in a sorption separation machine is continuously rotating and must maintain a high reliability, wearable seal elements that can independently move from the rotor and the stator are integrated such that no gap between the motive seal face on the rotor and the stator develop overtime with the progressive wear of the material.

Low friction material can also be used for the operating of the multi-selector valve, to ensure that the selector valve can operate continuously without any liquid fluid lubrication. Excessive friction can result in excess energy spent to rotate the valve and excess heat generation at the interface between rotor and stator.

In embodiments, the wearable seal elements can be made with Teflon (PTFE).

In embodiments, a seal-face or a counter-face plate can be rigidly supported to a structure or rails, while the corresponding seal-face or counter-face plate is pneumatically urged towards the rigidly supported seal-face or counter-face. In embodiments, one or both counter-face elements and seal-faces can move in a direction perpendicular to a slip plane, independently from the motion of the sorbent vessel in the same direction.

In an embodiment, a sorptive gas separator can include a rotating toroid for supporting a plurality of sorbent vessels, each vessel containing sorbent contactors, a set of ducts and duct connectors, a support structure for the drive and wheels supporting the rotating toroid, as well as positioning the set of ducts and duct connectors for forming a stator assembly, seal assemblies including flexible wearable seal components in contact with the moving toroid seal face or seal faces and subject to friction. The sorptive gas separator can be fluidly connected to at least a duct for conveying a feed stream, a duct for conveying a regeneration stream, a duct for conveying a product stream and a duct for conveying a waste product stream. The sorptive gas separator can further comprise a duct for conveying a conditioning stream. In embodiments, the sorptive gas separator can also comprises a power connection and a control system for regulating the rotation speed of the toroid. Embodiments of the sorptive gas separator further comprises a connection and means to monitor the performance of the separation system by measuring at least one of gas composition, gas temperature, gas density and gas pressure.

In embodiments, the solid sorbent contained in each of the sorbent vessels can have a selective adsorption capacity for at least one of the feed stream components.

In embodiments where the sorbent vessels move along a looped path, the sorbent vessels can transfer significant loads to a support structure, and the support structure can deflect greater than 1 mm in some embodiment, deflect greater than 10 mm in other embodiments, and in some embodiments, can deflect greater than 30 mm. The forces applied are due to the weight of the vessel and sorbents in a vertical direction and the force of fluid friction and fluid head loss in the direction of flow between inlet and outlet ports of the sorbent vessels or counter-face elements.

In embodiments where the sorbent vessels move along a looped path, a first set of rails or tracks can be employed for guiding the motion of the sorbent vessels and associated structural elements, while a second and, optionally, a third set of tracks or rails can be employed for guiding the motion of counter-face elements. The distance between a center of the sorbent vessel and a center of the counter-face element can change along the loop or path travelled by the vessel and counter-face. Telescopic joints or flexible joints can be placed between the counter-face element(s) and one or more fluid ports of a sorbent vessel, for example an inlet port and an outlet port, to provide a continuous flow path for the process streams in and out of the moving sorbent vessel.

In embodiments where sorbent vessels move along a looped path, each of the duct diffusing elements or diffusers enclose and direct a process gas stream to, or a product gas stream from, one or more sorbent vessels. In certain embodiments, the movement can be to and/or from four (4) sorbent vessels, in other embodiments, to and/or from three (3) sorbent vessels, in some embodiments, to and/or from two (2) sorbent vessels, and in some embodiments, to and/or from one (1) sorbent vessel.

In embodiments, a plurality of diffusers can be fluidly connected to a common or single duct for enclosing and directing a process stream or a product stream. A preferred embodiment of the multi-stream selector valve or sorption separation machines can include a number of openings across the seal face in contact with the inlet streams which is at least twice the number of inlet streams connected to the selector valve. This enables an uninterrupted flow between inlet and outlet ducts as the toroid rotates since the radial seal elements tend to only close a single opening at a time. In an embodiment, the selector valve can be configured with two (2) to twenty (20) inlet streams.

In embodiments where the sorbent vessels move along a looped or circular path, an offset of stream connections from balance of plant to adjacent diffusers is repeated in the same sequence to enable the separation process to be carried out more than once per loop of travel for a sorbent bed. This arrangement enables greater degrees of freedom for the ducting system compared to a ducting system comprised of larger diffuser sections, as each seal-face attached to the end of the diffuser can sit on a set of counter-face elements at different elevation, pitch and roll.

In embodiments, the multi-stream selector valve can includes a mohs hardness of the moving toroidal seal face that is greater than 4, and preferably greater than 6, while the wearable stator seal component hardness is less than 3 Mohs scale. Preferably the moving toroidal seal surface can be comprised of steel and the wearable stator seal component is comprised of Teflon.

The multi-stream selector valve can be fluidly connected to inlet fluid streams and/or outlet fluid streams having average fluid velocities typically in the range of 0.2 to 20 m/s, as measured at the seal face opening. Embodiments can include a provision for the inlet and outlet streams potentially over a plurality of selector valves to be at least periodically connected through the toroid to enable continuous flow through the toroid through at least a portion of the sorbent vessels. The operation of the valves can be effected so that an average of the inlet and outlet flow is substantially equal, over a period of one rotation of the torus. The arrangement of multi-stream selector valve components including the duct transitions and radial seal assemblies over the surface of the toroid can cover at least 350 degrees of the toroid angular surface. The multi-stream selector valve can comprise wearable seal elements that are free to move in a direction of the axis of rotation by greater than 10 mm, and preferably greater than 20 mm. This enables or otherwise allows the wearable elements to lose up to that amount of material through wear while maintaining an effective seal, and additionally, it can accommodate defects in planarity of the toroid. The wear element of the seal system can lose up to 60% of its thickness and still maintain an effective seal, because the inflatable bladder filled with a pressurized gas or liquid and support groove is designed to accommodate that range of motion, and the corresponding seal wear element material loss. In an embodiment, the multi-stream selector valve and seal system can have an inner diameter that is equal to or greater than 4 meters.

In embodiments, the seal wear elements can be formed into a ring around the inner and outer perimeters of the toroid seal face(s), and the seal wear elements can have a flexural modulus of less than 0.4 GPa and can be bent to conform to the seal face of the rotor by applying a force of less than 4 psi (˜30 kPa) to the element face on the opposite face to the face contact to deflect the seal element by up to 2 mm per meter of seal element length. The wearable seal elements can be segments of the inner and outer perimeter of the toroid and can comprise multiple layers of wearable seal elements arranged in concentric fashion once formed as a ring.

The multiple concentric elements construction of the wearable seal elements enables a greater flexibility of the wearable elements by facilitating the deformation of the wearable seal elements in a direction perpendicular to the bend radius. Compressible elements can be included into the wearable seal element to further enhance their flexibility.

In embodiments, the radial seal elements have a width that is greater than the width of the openings through the toroid seal face, and preferably equal to or greater than the width formed by an angular segment of 360 divided by the number of vessels affixed to the toroid or the number of openings through the seal face connecting to the sorbent vessels. This enables the intermittent formation of a radial seal at both the leading and trailing edges of the openings in the seal face in the direction of rotation to prevent fluid from flowing between ducts carrying different streams. In embodiments, the radial seal elements can be formed by a plate supporting multiple wiper seal placed in a direction essentially perpendicular to the tangential motion of the toroid when spinning.

In an embodiment, the wiper seals of the multi-stream selector valve can have a short axis which can be tilted between 10 and 40 degrees relative to the rotation axis.

In an embodiment, a method of operating an adsorptive gas separator for separating a first component from a multi-component fluid stream, the method comprises:
a. providing a toroidal sorptive gas separator;
b. transferring a motive force from a plurality of motors to the toroid to move a plurality of selective absorption vessels;
c. fluidly connecting said plurality of said vessel with a feed stream duct and a first product stream duct;
d. directing said multi-component fluid stream as a feed stream to a plurality of said vessels, sorbing said first component on a sorbent of plurality of said selective absorption vessels and forming a first product stream depleted in said first component relative to said feed stream, recovering a first product stream from plurality of said vessels and directing said first product stream into said first product stream duct;
e. fluidly connecting sad sorbent of said plurality of said vessels with said first regeneration stream duct and said second product stream duct; and
f. directing a first regeneration stream to said plurality of said vessels; and desorbing said first component from said second vessel and forming a second product stream enriched in said first component relative to said feed stream, recovering said second product stream from said plurality of said vessel, and directing said second product stream into said second product stream duct.

In a further embodiment, the method of operating an adsorptive gas separator further comprises:
g. fluidly connecting said sorbent of a plurality of said vessels with said second regeneration stream duct and said third product stream duct;
h. admitting a second regeneration stream to contact said sorbent of said plurality of said vessels and forming a third product stream, recovering said third product stream from said plurality of said vessel, and directing said third product stream into said third product stream duct;
i. fluidly connecting said sorbent of said plurality of said vessels with said conditioning stream duct and said fourth product stream duct; and
j. admitting a conditioning stream to contact said sorbent of said plurality of said vessels and forming a fourth product stream, recovering said fourth product stream from said plurality of said vessels, and directing said fourth product stream into said fourth product stream duct.

In a further embodiment, the method of operating an adsorptive gas separator further comprises of repeating steps b to f.

In a further embodiment, the method of operating an adsorptive gas separator further comprises repeating steps b to j.

In a further embodiment, the method of operating the innovative adsorptive gas separator, purifies the multi-component fluid stream from at least one or an industrial process gas stream, a commercial process gas stream, and a combustion gas stream, and said first component is an acid gas component, carbon dioxide, sulphur oxide, nitrogen, or oxygen.

### EXAMPLES

### Example 1

A 14 meters outer diameter sorbent machine structure with about 11 meters inner diameter, comprising a rotating torus of about 1.2 meter in thickness was designed and built to validate the design and predicted Finite Element Analysis level of flatness of the torus seal surfaces. Both upper and lower side of the torus, rotating around a vertical axis, are seal surfaces with 48 openings to connect inlet and outlet gas streams to the plurality of sorbent vessels supported within the torus. The sorptive gas separator was fabricated as 8 torus segments bolted together in the field and supported by 8 wheels placed under the inner diameter of a cantilevered rail. Traction of the motorized wheels was tested as well as the effect of the effect of imperfection of the level of flatness of the toroid on the vertical force distribution on the support and drive wheels. FIGS. 13, 14 and 15 discussed above show respectively a picture of the machine prior to sorbent bed and ducting installation, the variation of force during one rotation of the torus at one selected wheel and the measurement of degree of flatness along a circular path on the bottom seal face.

### Example 2

A composite wearable seal element formed from three stacked layers arranged in concentric fashion around a 6″ diameter cylindrical support.

The three layers are from ID to OD: Teflon 5 mm, carbon rope packing 15 mm and Teflon 5 mm. The assembly was pressed against a steel surface with roughness of 1 micron RMS using 50 kPa of force and rotating composite wearable seal assembly at 180 rpm for 415 hours while monitoring the seal thickness reduction and mass loss from attrition periodically and measuring leak rates across the seal.

The leak rate was maintained within specification of less than 10 L/min per m of seal length (about 8 L/min) while the attrition rate measured at about 8 micron per day (˜3 mm per year).

Embodiments disclosed herein allow for various configuration options which may accommodate desired variations of gas separation processes and associated process cycles. Process cycles are defined at least in part by the fraction of beds exposed to specific process streams as well as cycle duration. The modular approach enables multiple design applications to be addressed using a common set of building elements for sorptive gas separators. For example, different sorbent materials can be used as a function of the partial pressure of a component to be concentrated. Each sorbent material will have a unique preferred set of operating conditions including, for example, a feed step duration, a regeneration step duration and a conditioning step duration, to increase the effectiveness and/or efficiency of a gas separation process. The ability to adjust the number of sorbent contactor beds for every process step is highly advantageous while facilitating mass production of these machines by using the same design building blocks in the different variant of the machines deployed in the field.

One other important design feature exemplified in the various figures is a diffuser designed to distribute a gas stream to a limited number of sorbent vessels in parallel. A plurality of diffusers may be employed and fluidly connected to one or more ducts to supply a process stream, for example, a feed stream and/or a second regeneration stream.

This exemplary design also allows for distribution of the different process and product streams for a gas separation process in such a way that one or an integral number of process cycles for a sorbent is carried out when a sorbent vessel completes a single loop of a sorptive gas separator.

Additionally, the multi-segmented design of the cooperating seal-face and counter-face elements reduces the undesirable effect of thermal expansion and deformation of the support structure by providing additional degrees of freedom for the expansion. For example, expansion joints can be placed between each counter-face plate and/or element reducing the risk of stress accumulation in some areas.

The moving or motive elements of a sorptive gas separator may be exposed to process streams with a temperature varying between an ambient temperature and about 100° C., or an ambient temperature and several hundred degrees Celsius. The operating temperature of the moving elements is expected to reach a temperature significantly higher than ambient temperature due to the exposure to the process streams and the heat generated from the friction of the sliding seal-faces. As a result, some elements of the support structure can thermally expand significantly more than some other elements of the support structure. These differences in operating temperature are accommodated in embodiments of the design described herein by enabling some elements to expand and not overly constraining this expansion.

1. A rotating toroid comprising:
a toroid with at least one substantially flat or in a shape of a frustum of a cone face which is adapted to be used as an interface for at least one sliding seal or at least one seal face integrated in a sorptive gas separator or a multi-stream selector valve,
wherein at least one circular rail operatively connected to an inner diameter of the toroid and a set of wheels is placed in fixed positions and distributed at angular increments along the inner diameter for contacting the at least one circular rail,
wherein the set of wheels are adapted to provide reacting forces to a static load of the toroid, and at least one wheel of the set of wheels is adapted to provide a motive force for rotating the toroid, without being driven or supported by a central shaft.

2. The rotating toroid of claim 1, wherein the toroid further comprises an outer diameter, and has an outer diameter to inner diameter ratio of less than 1.5.

3. The rotating toroid of claim 1, wherein the toroid further comprises a protrusion for operatively connecting to the at least one circular rail.

4. The rotating toroid of claim 3, wherein the protrusion has a cantilever cross section.

5. The rotating toroid of any one of claims 1 to 4, wherein the toroid further comprises a substantially vertical rotation axis,
wherein the set of wheels are circumferentially evenly distributed along the inner diameter,
wherein the set of wheels further comprises at least two wheels with motors attached thereto for providing the motive force, and at least 4 support wheels for a toroid having a 4 meter inner diameter, at least 8 support wheels for a toroid having a 10 meter inner diameter, at least 12 support wheels for a toroid having a 20 meter inner diameter and 16 support wheels for a toroid having a 30 meter inner diameter.

6. The rotating toroid of any one of claims 1 to 5, wherein the at least one seal face further comprises a plurality of openings, each having a surface area, to enable fluid flow across the at least one seal face of the toroid, wherein a sum of the surface areas of the plurality of openings is at least 30% of a surface area of the at least one seal face and at most 90% of the surface area of the at least one seal face.

7. The rotating toroid of any one of claims 1 to 6, further comprising an outer diameter face having a plurality of openings for inserting a plurality of sorbent vessels therethrough and within the toroid.

8. The rotating toroid of any one of claims 1 to 7, wherein the inner diameter is greater than 4 m and less than 50m.

9. The rotating toroid of any one of claims 1 to 8, wherein a toroid dimension in a direction of the axis of rotation is between 0.5 and 2.5m.

10. The rotating toroid of any one of claims 1 to 9, further comprising an assembly of more than one toroid segments positioned and attached to form the toroid.

11. The rotating toroid of claim 8, wherein the rotating toroid achieves a displacement of less than 2 mm at the seal face in a direction of the axis of rotation of the toroid when the toroid is rotated such that one meter of displacement is achieved in a circular direction around a center of rotation of the toroid.

12. The rotating toroid of any one of claims 1 to 11, wherein the toroid further comprises two opposing seal faces.

13. The rotating toroid of claim 10, wherein the toroid further comprises at least 4 toroid segments which are combined and attached to form 360 degrees of the toroid.

14. A sorptive gas separator comprising:
a rotating toroid of any one of claims 1 to 13;
a plurality of vessels containing sorbent contactors;
a plurality of ducts and duct connectors;
a support structure for a drive and wheels supporting the toroid as well as positioning the ducts and duct connectors for forming a stator assembly; and
a seal assembly including flexible wearable seal components, the seal assembly being subject to friction,
wherein the sorptive gas separator is adapted to be connected to at least a duct for conveying a feed stream, a duct for conveying a regeneration stream, a duct for conveying a product stream, and a duct for conveying a waste product stream.

15. The sorptive gas separator of claim 14, further comprising a duct for conveying a conditioning stream.

16. The sorptive gas separator of claim 14 or 15, further comprising a power connection and a control system for regulating a rotation speed of the toroid.

17. The sorptive gas separator of claim 16, further comprising a monitoring means for measuring a performance parameter of the separator of at least one of gas composition, gas temperature, gas density and gas pressure.

18. A sorptive gas separator, for separating a first component from a multi-component fluid stream, said sorptive gas separator comprising:
a. the toroid of any one of claims 1 to 13;
b. a plurality of vessels, wherein said plurality of vessels are rotating with the toroid and each house a sorbent for sorbing said first component therein from said multi-component fluid stream;
c. a seal assembly having duct connectors, inner and outer perimeter seals, and radial seals
d. a plurality of motors for transferring a motive force to said plurality of vessels;
e. a first process stream duct for directing said multi-component fluid stream as a feed stream to said plurality of vessels, wherein said feed stream duct is substantially stationary;
f. a first product stream duct for directing a first product stream recovered from said plurality of vessels, wherein said first product stream duct is substantially stationary;
g. a second process stream duct for directing a first regeneration stream to said plurality of vessels, wherein said first regeneration stream duct is substantially stationary; and
h. a second product stream duct for directing a second product stream recovered from said plurality of vessels, wherein said second product stream duct is substantially stationary.

19. The sorptive gas separator of any one of claims 14 to 18, further comprising two seal faces located on opposing sides of the toroid, wherein each of the two seal faces is in contact with a seal system having a duct connector and a gas distribution system connecting the ducts across the plurality of vessels placed within the toroid.

20. The sorptive gas separator of any one of claims 14 to 19, wherein each of the said plurality of vessels are in the shape of a rectangular prism.

21. The sorptive gas separator of any one of claims 14 to 20, wherein each of the plurality of the vessels contains a contactor with a solid sorbent having a selective adsorption capacity for at least one of the feed stream components.

22. The sorptive gas separator of any one of claims 14 to 21, wherein the duct are rated and sized to direct the feed stream and/or the first regeneration stream at a pressure equal to or less than 100 kPa (g).

23. The sorptive gas separator of any one of claims 14 to 22, wherein said opening through the seal-face and/or said counter-face comprises a flow coefficient value or a Cᵥ value of equal to or greater than 75,000, 100,000, 250,000, 500,000, 700,000 or 1,000,000.

24. The sorptive gas separator of any one of claims 14 to 23, where each piece of the sorptive gas separator is sized to be transported on a flatbed truck with a maximum dimension of 12 m length, 2.9 m height and 2.4 m width.

25. The sorptive gas separator of any one of claims 14 to 24, wherein a weight of a toroid structure supporting the plurality of vessels is less than twice a weight of the plurality of vessels loaded with sorbent affixed to the rotating toroid.

26. The sorptive gas separator of any one of claims 23 to 25, wherein a force applied on the toroid by at least one of a feed stream, a first regeneration stream, and a conditioning stream head losses across the sorbent contactor is less than 20,000 Pa in a direction of the flow, and preferably less than 10,000 Pa.

27. A sorptive gas separator comprising:
a) a rotating assembly for rotating around an axis having:
1. a toroid shaped structure having an interior side located on an inner perimeter of said rotating assembly, an exterior side located on an outer perimeter of said rotating assembly, a first span located between said interior side and said exterior side, a second span located between said interior side and said exterior side,
2. a plurality of vessels, attachable within said toroid shaped structure, enclosing a solid sorbent, said plurality of vessels having an inlet and an outlet in fluid communication with said solid sorbent,
3. at least one protrusion attached to said interior side of said toroid shaped structure;
b) a stationary assembly having a plurality of drive wheels, said plurality of drive wheels coupled to a plurality of motors for transferring a motive force for moving said toroid shaped structure around said axis; and
c) at least one seal system for directing process streams through the said plurality of vessels and directing a product stream from said plurality of vessels, the at least one seal system comprising a rotor seal face and a stator side wearable seal assembly,
wherein said stationary assembly is located within said interior side of said toroid shaped structure.

28. The sorptive gas separator of claim 27, wherein said toroid shaped structure further comprises an outer diameter and an inner diameter, wherein a ratio of the outer diameter to the inner diameter ratio is less than 1.5.

29. The sportive gas separator of claim 27 or 28, further comprising:
a first plurality of ducts, wherein said first plurality of duct is adapted for conveying a fluid, and is located adjacent to said first span, and
a second plurality of ducts, wherein said second plurality of ducts is adapted for conveying a fluid, and is located adjacent to said second span,
wherein said first and second pluralities of ducts are stationary and in fluid communication with said inlet and said outlet of said plurality of vessels.

30. The sportive gas separator of claim 27, 28 or 29, wherein said plurality of vessels is conveyable from said exterior side of said toroid shaped support structure.

31. The sportive gas separator of any one of claims 27 to 30, wherein said at least one protrusion is a cantilever.

32. The sportive gas separator of any one of claims 27 to 31, wherein said plurality of drive wheels is adapted to bear a weight greater than 50% of a weight of the rotating assembly.

33. A method of operating an adsorptive gas separator for separating a first component from a multi-component fluid stream, said method comprising:
a. providing said sorptive gas separator of any one of claims 14 to 32;
b. transferring a motive force from said plurality of motors to the toroid for moving said plurality of vessels;
c. fluidly connecting said plurality of said plurality of vessels with a feed stream duct and a first product stream duct;
d. directing said multi-component fluid stream as a feed stream to said plurality of vessels, sorbing said first component onto said sorbent of said plurality of vessels for forming a first product stream depleted in said first component relative to said feed stream, recovering said first product stream from said plurality of vessels and directing said first product stream into said first product stream duct;
e. fluidly connecting said sorbent of said plurality of vessels with said first regeneration stream duct and said second product stream duct; and
f. directing a first regeneration stream to said plurality of vessels, desorbing said first component from said plurality of vessels for forming a second product stream enriched in said first component relative to said feed stream, recovering said second product stream from said plurality of vessels, and directing said second product stream into said second product stream duct.

34. The method of claim 33, further comprising:
a. fluidly connecting said sorbent of said plurality of vessels with said second regeneration stream duct and a third product stream duct;
b. admitting a second regeneration stream to come into contact with said sorbent of said plurality of vessels for forming a third product stream, recovering said third product stream from said plurality of vessels, and directing said third product stream into said third product stream duct;
C fluidly connecting said sorbent of said plurality of vessels with said conditioning stream duct and a fourth product stream duct; and
d. admitting a conditioning stream to contact said sorbent of said plurality of vessels for forming a fourth product stream, recovering said fourth product stream from said plurality of vessels, and directing said fourth product stream into said fourth product stream duct.

35. The method of any one of claims 33 to 34, wherein said multi-component fluid stream is at least one of an industrial process gas stream, a commercial process gas stream, and a combustion gas stream, and said first component is an acid gas component, carbon dioxide, sulphur oxide, nitrogen, or oxygen.

36. The method of any one of claims 33 to 35, further comprising moving said plurality of vessels along a track, wherein said plurality of vessels move with one to three degrees of freedom, particularly one to two degrees of freedom, when mated and relative to said track.

37. The method of any one of claims 33 to 36, further comprising moving said toroid with a plurality of vessels, on a substantially horizontal plane in a path or loop which is substantially a circular path.

38. The method of any one of claims 33 to 37, further comprising moving said plurality of vessels is a substantially continuous motion during one full rotation, at a substantially continuous speed and/or at a substantially constant speed within a range of 10% of an average speed of rotation.

39. The method of claim 38, wherein the rotational speed of the toroid is between 0.5 rpm and 10 rpm.
